(19) United States
(12) Patent Application Publication
(10) Pub. No.: US 2026/0253403 A1
(43) Pub. Date: Aug. 27, 2026

(54) HIERARCHICAL VISION ENCODING ENABLED COGNITIVE ANALYSIS BASED ON IMAGE-FEATURE GROUP (IFG) IDENTIFIERS

(71) Applicant: QUALCOMM Incorporated, San Diego, CA (US)

(72) Inventors: Titash RAKSHIT, Austin, TX (US); Munawar HAYAT, San Diego, CA (US)

(21) Appl. No.: 19/543,609

(22) Filed: Feb. 18, 2026

Related U.S. Application Data
(60) Provisional application No. 63/764,265, filed on Feb. 27, 2025.

(51) Int. Cl. G06V 10/82; G06V 10/762; G06V 20/20; G06V 20/59; G10L 15/16; G10L 15/183; G10L 15/22; H04N 19/30

(52) U.S. Cl. CPC G06V 10/82; G06V 10/762; G10L 15/16; G10L 15/183; G10L 15/22; H04N 19/30; G06V 20/20; G06V 20/59; G10L 2015/223

(57) ABSTRACT

A device includes a memory configured to store one or more image-feature group (IFG) identifiers. The device also includes one or more processors coupled to the memory and configured to process, at a hierarchical vision encoder (HVE), an image frame of a sequence of image frames to generate image latent data. The image latent data corresponds to a downscaled representation of the image frame. The one or more processors are also configured to process the image latent data to generate a set of IFG identifiers. The one or more processors are further configured to add the set of IFG identifiers to image analysis data used to represent the sequence of image frames for image-based cognitive analysis.

### CROSS-REFERENCE TO RELATED APPLICATIONS

The present application claims priority from Provisional Patent Application No. 63/764,265, filed Feb. 27, 2025, and entitled “HIERARCHICAL VISION ENCODING ENABLED COGNITIVE ANALYSIS BASED ON IMAGE-FEATURE GROUP (IFG) IDENTIFIERS,” which is incorporated herein by reference in its entirety.

### FIELD

The present disclosure is generally related to hierarchical vision encoding enabled cognitive analysis.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture image frames from a camera. The image frames can be used as input for further analysis, such as generating responses to image-related queries. A computing device typically has limited storage capacity that restricts the number of image frames that can be retained for later use. Transmitting the image frames to another device that may have more storage capacity for analysis can use significant bandwidth.

### SUMMARY

According to one implementation of the present disclosure, a device includes a memory configured to store one or more image-feature group (IFG) identifiers. The device also includes one or more processors coupled to the memory and configured to process, at a hierarchical vision encoder (HVE), an image frame of a sequence of image frames to generate image latent data. The image latent data corresponds to a downscaled representation of the image frame. The one or more processors are also configured to process the image latent data to generate a set of IFG identifiers. The one or more processors are further configured to add the set of IFG identifiers to image analysis data used to represent the sequence of image frames for image-based cognitive analysis.

According to another implementation of the present disclosure, a device includes a memory configured to store one or more image-feature group (IFG) identifiers. The device also includes one or more processors coupled to the memory and configured to receive, from a second device, a set of IFG identifiers representing an image frame. The one or more processors are also configured to determine IFG latent data corresponding to the set of IFG identifiers. The one or more processors are also configured to generate image tokens based on the IFG latent data. The one or more processors are further configured to generate linguistic tokens based on a query. The one or more processors are also configured to use a multimodal transformer network to perform image-based cognitive analysis based on the image tokens and the linguistic tokens to generate a response.

According to another implementation of the present disclosure, a method includes processing, at a hierarchical vision encoder (HVE), an image frame of a sequence of image frames to generate image latent data. The image latent data corresponds to a downscaled representation of the image frame. The method also includes processing the image latent data to generate a set of IFG identifiers. The method also includes adding the set of IFG identifiers to image analysis data used to represent the sequence of image frames for image-based cognitive analysis.

According to another implementation of the present disclosure, a method includes receiving, at a first device from a second device, a set of image-feature group (IFG) identifiers representing an image frame. The method also includes determining, at the first device, IFG latent data corresponding to the set of IFG identifiers. The method also includes generating, at the first device, image tokens based on the IFG latent data. The method also includes generating, at the first device, linguistic tokens based on a query. The method also includes using, at the first device, a multimodal transformer network to perform image-based cognitive analysis based on the image tokens and the linguistic tokens to generate a response.

According to another implementation of the present disclosure, a non-transitory computer-readable medium stores instructions that, when executed by one or more processors, cause the one or more processors to process, at a hierarchical vision encoder (HVE), an image frame of a sequence of image frames to generate image latent data. The image latent data corresponds to a downscaled representation of the image frame. The instructions further cause the one or more processors to process the image latent data to generate a set of IFG identifiers. The instructions further cause the one or more processors to add the set of IFG identifiers to image analysis data used to represent the sequence of image frames for image-based cognitive analysis.

According to another implementation of the present disclosure, a non-transitory computer-readable medium stores instructions that, when executed by one or more processors, cause the one or more processors to receive, from a device, a set of image-feature group (IFG) identifiers representing an image frame. The instructions further cause the one or more processors to determine IFG latent data corresponding to the set of IFG identifiers. The instructions further cause the one or more processors to generate image tokens based on the IFG latent data. The instructions further cause the one or more processors to generate linguistic tokens based on a query. The instructions further cause the one or more processors to use a multimodal transformer network to perform image-based cognitive analysis based on the image tokens and the linguistic tokens to generate a response.

According to another implementation of the present disclosure, an apparatus includes means for processing, at a hierarchical vision encoder (HVE), an image frame of a sequence of image frames to generate image latent data. The image latent data corresponds to a downscaled representation of the image frame. The apparatus further includes means for processing the image latent data to generate a set of IFG identifiers. The apparatus further includes means for adding the set of IFG identifiers to image analysis data used to represent the sequence of image frames for image-based cognitive analysis.

According to another implementation of the present disclosure, an apparatus includes means for receiving, from a device, a set of image-feature group (IFG) identifiers representing an image frame. The apparatus further includes means for determining IFG latent data corresponding to the set of IFG identifiers. The apparatus further includes means for generating image tokens based on the IFG latent data. The apparatus further includes means for generating linguistic tokens based on a query. The apparatus further includes means for using a multimodal transformer network to perform image-based cognitive analysis based on the image tokens and the linguistic tokens to generate a response.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1A is a block diagram of a particular illustrative example of a system operable to perform hierarchical vision encoding enabled cognitive analysis, in accordance with some examples of the present disclosure.

FIG. 1B is a diagram of an illustrative example of a hierarchical vision encoder, in accordance with some examples of the present disclosure.

FIG. 2 is a diagram of another illustrative example of a system operable to perform hierarchical vision encoding enabled cognitive analysis, in accordance with some examples of the present disclosure.

FIG. 3 is a diagram of an illustrative example of an image-based cognitive analyzer, in accordance with some examples of the present disclosure.

FIG. 4 illustrates an example of an integrated circuit operable to perform hierarchical vision encoding enabled cognitive analysis, in accordance with some examples of the present disclosure.

FIG. 5 is a diagram of a mobile device operable to perform hierarchical vision encoding enabled cognitive analysis, in accordance with some examples of the present disclosure.

FIG. 6A is a diagram of a wearable electronic device operable to perform hierarchical vision encoding enabled cognitive analysis, in accordance with some examples of the present disclosure.

FIG. 6B is a diagram of a mobile device and a wearable electronic device operable to perform hierarchical vision encoding enabled cognitive analysis, in accordance with some examples of the present disclosure.

FIG. 7A is a diagram of a mixed reality or augmented reality glasses device operable to perform hierarchical vision encoding enabled cognitive analysis, in accordance with examples of the present disclosure.

FIG. 7B is a diagram of a mobile device and a mixed reality or augmented reality glasses device operable to perform hierarchical vision encoding enabled cognitive analysis, in accordance with examples of the present disclosure.

FIG. 8A is a diagram of a voice-controlled speaker system operable to perform hierarchical vision encoding enabled cognitive analysis, in accordance with some examples of the present disclosure.

FIG. 8B is a diagram of a mobile device and a voice-controlled speaker system operable to perform hierarchical vision encoding enabled cognitive analysis, in accordance with some examples of the present disclosure.

FIG. 9A is a diagram of a camera operable to perform hierarchical vision encoding enabled cognitive analysis, in accordance with some examples of the present disclosure.

FIG. 9B is a diagram of a mobile device and a camera operable to perform hierarchical vision encoding enabled cognitive analysis, in accordance with some examples of the present disclosure.

FIG. 10A is a diagram of a headset, such as a virtual reality, mixed reality, or augmented reality headset, operable to perform hierarchical vision encoding enabled cognitive analysis, in accordance with some examples of the present disclosure.

FIG. 10B is a diagram of a mobile device and a headset, such as a virtual reality, mixed reality, or augmented reality headset, operable to perform hierarchical vision encoding enabled cognitive analysis, in accordance with some examples of the present disclosure.

FIG. 11A is a diagram of a first example of a vehicle operable to perform hierarchical vision encoding enabled cognitive analysis, in accordance with some examples of the present disclosure.

FIG. 11B is a diagram of a mobile device and the first example of a vehicle operable to perform hierarchical vision encoding enabled cognitive analysis, in accordance with some examples of the present disclosure.

FIG. 12A is a diagram of a second example of a vehicle operable to perform hierarchical vision encoding enabled cognitive analysis, in accordance with some examples of the present disclosure.

FIG. 12B is a diagram of a mobile device and the second example of a vehicle operable to perform hierarchical vision encoding enabled cognitive analysis, in accordance with some examples of the present disclosure.

FIG. 13 is a diagram of a particular implementation of a method of performing hierarchical vision encoding enabled cognitive analysis that may be performed by the devices of FIGS. 1A and 2, in accordance with some examples of the present disclosure.

FIG. 14 is a diagram of a particular implementation of a method of performing hierarchical vision encoding enabled cognitive analysis that may be performed by the device of FIG. 2, in accordance with some examples of the present disclosure.

FIG. 15 is a block diagram of a particular illustrative example of a device that is operable to perform hierarchical vision encoding enabled cognitive analysis, in accordance with some examples of the present disclosure.

### DETAILED DESCRIPTION

Cognitive analysis can be performed on image frames, such as to generate responses to image-related queries. Limited storage capacity at a device can restrict the number of image frames that can be stored and made available for further analysis. Transmitting the image frames to another device that may have more storage capacity for analysis can use significant bandwidth.

Systems and methods of hierarchical vision encoding enabled cognitive analysis are disclosed. For example, a hierarchical vision encoder (HVE) processes an image frame to generate a set of image-feature group (IFG) identifiers that represent the image frame for cognitive analysis.

As used herein, an IFG is represented by IFG latent data (e.g., a representative value) that corresponds to (e.g., is an approximation of and is considered to match) multiple sets of image latent data. In some examples, an IFG can correspond to a cluster of the sets of image latent data, and the IFG latent data can correspond to a representative value (e.g., a centroid, a medoid, or both) of the cluster. In an example, a first IFG (e.g., a first feature embedding cluster) corresponds to a first plurality of image embeddings and is represented by first IFG latent data (e.g., a first cluster feature embedding) that corresponds to a representative value (e.g., a first cluster centroid) of the first IFG. As another example, a second IFG (e.g., a second feature embedding cluster) corresponds to a second plurality of image embeddings and is represented by second IFG latent data (e.g., a second cluster feature embedding) that corresponds to a representative value (e.g., a second cluster centroid) of the second IFG. Similarly, a third IFG is represented by third IFG latent data, a fourth IFG is represented by fourth IFG latent data, and so on.

Using a first stage of the HVE, an image frame is processed to generate first image latent data that corresponds to a first downscaled representation of the image frame. A second stage of the HVE processes the first image latent data to generate second image latent data that corresponds to a second downscaled representation of the image frame. For example, the second downscaled representation corresponds to additional downscaling of the first downscaled representation. Each subsequent stage of the HVE processes previous image latent data generated by a prior stage of the HVE to generate image latent data that corresponds to an additionally downscaled representation of the image frame. In an example, the HVE includes a convolutional neural network (CNN) and each stage of the HVE corresponds to a respective convolutional layer of the CNN. In a particular example, the image latent data includes a plurality of image feature embeddings. To illustrate, the image latent data includes first image latent data (e.g., a first image feature embedding), second image latent data (e.g., a second image feature embedding), third image latent data (e.g., a third image feature embedding), etc.

The image latent data is processed, using a latent-to-IFG (L2I) resolver, to generate the set of IFG identifiers. For example, the L2I resolver selects the IFGs that match the image latent data (e.g., the plurality of image feature embeddings) and outputs the set of IFG identifiers of the selected IFGs. To illustrate, the L2I resolver identifies the first IFG latent data (e.g., the first cluster feature embedding) as a match (e.g., a nearest neighbor) of the first image latent data (e.g., the first image feature embedding) and adds a first IFG identifier (e.g., a first cluster identifier) of the first IFG to the set of IFG identifiers. The first IFG latent data corresponds to an approximation of the first image latent data. Similarly, the L2I resolver identifies the second IFG latent data (e.g., the second cluster feature embedding) as a match (e.g., a nearest neighbor) of the second image latent data (e.g., the second image feature embedding) and adds a second IFG identifier (e.g., a second cluster identifier) of the second IFG to the set of IFG identifiers. The second IFG latent data corresponds to an approximation of the second image latent data. The set of IFG identifiers (e.g., cluster identifiers) can thus identify IFGs (e.g., a plurality of feature embedding clusters) that represent IFG latent data (e.g., cluster feature embeddings) that approximates the image latent data (e.g., the plurality of image feature embeddings) that corresponds to a downscaled representation of the image frame. It should be understood that cluster centroids are provided as an illustrative example of representative values of IFGs, in other examples an IFG may be represented by a codebook entry, a bin value, a prototype feature, a medoid feature, another type of IFG representative value, or a combination thereof.

The set of IFG identifiers is added to image analysis data stored in a memory. Subsequently, when cognitive analysis based on the image frame is to be performed, the set of IFG identifiers representing the image frame is retrieved from the memory and an IFG-to-latent (I2L) resolver determines IFG latent data (e.g., the cluster feature embeddings) associated with the set of IFG identifiers (e.g., the cluster identifiers). The cognitive analysis is performed on the IFG latent data (e.g., the cluster feature embeddings) to generate a response to an image-related query.

The set of IFG identifiers has a smaller size than the original image frame. For example, fewer bits are used to store the set of IFG identifiers in the memory than bits that would be used to store the original image frame. Therefore, sets of IFG identifiers corresponding to a greater number of image frames can be stored in the memory more efficiently than storing the image frames themselves. Consequently, data from a greater number of image frames becomes accessible for cognitive analysis.

In some examples, because the IFG latent data represents an approximation of the image latent data corresponding to a downscaled representation of the image frame, the IFG latent data cannot typically be used to generate an accurate reproduction of the original image frame. Storing or transmitting the set of IFG identifiers thus provides enhanced security, as the set of IFG identifiers does not fully reveal content of the original image frame.

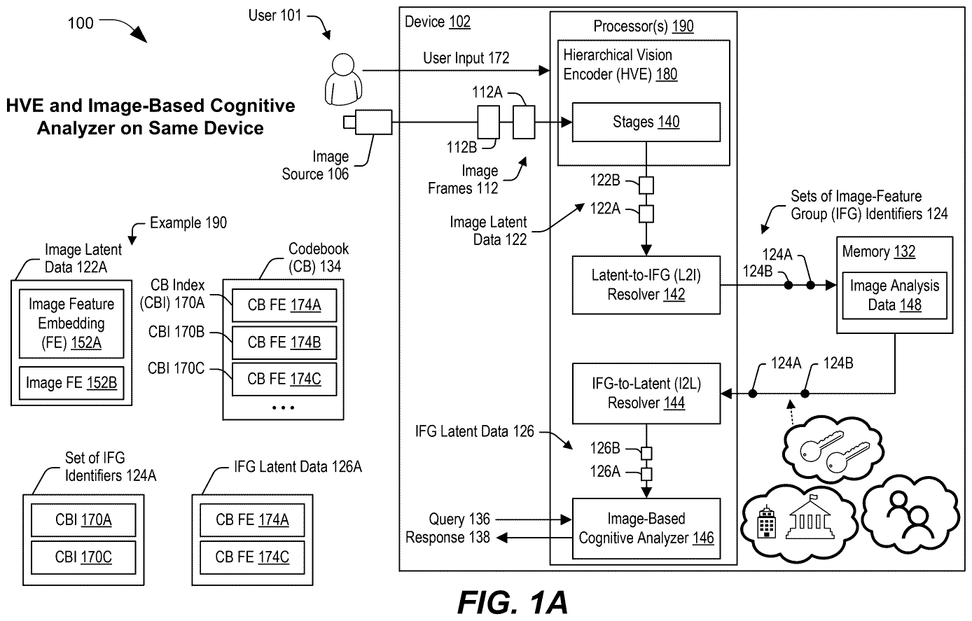

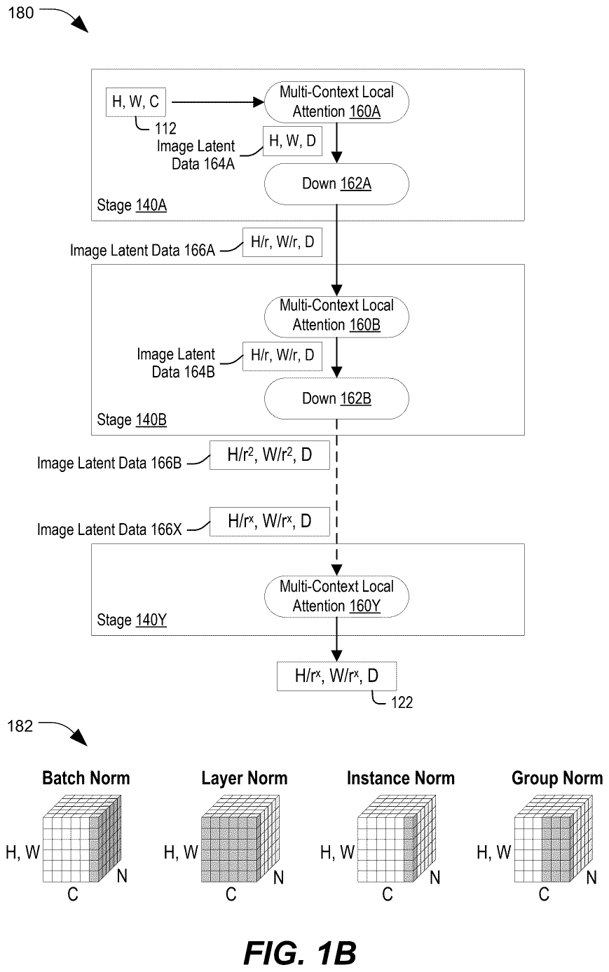

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a device 102 including one or more processors (“processor(s)” 190 of FIG. 1A), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple image frames are illustrated and associated with reference numbers 112A and 112B. When referring to a particular one of these image frames, such as an image frame 112A, the distinguishing letter “A” is used. However, when referring to any arbitrary one of these image frames or to these image frames as a group, the reference number 112 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “latent data” should be understood in accordance with any of its usual and customary meanings in the fields of computer science, data science, and/or machine learning. For example, latent data can be generated by a machine-learning model as a representation of data input to the machine-learning model. Generally, the latent data include values representing underlying patterns, structures, or features that the machine-learning model infers from the input data. Ideally, the latent data represents the input data in a manner that includes important and/or unique characteristics of the input data in view of a goal or purpose of the machine-learning model. To illustrate, image latent data described herein includes latent data representing characteristics of one or more images in a manner that is useful for image-based cognitive analysis.

As used herein, the term “hierarchical vision encoder” should be understood in accordance with any of its usual and customary meanings in the fields of computer science, data science, and/or machine learning. Generally, a hierarchical vision encoder corresponds to an encoder that includes at least two stages and is configured to process image data in a hierarchical manner (e.g., output of one stage is provided as input, possibly along with other data, to a subsequent stage). To illustrate, a hierarchical vision encoder described herein includes at least a first stage and a second stage. The first stage is configured to process image data of an image frame to generate first stage output (e.g., image latent data) corresponding to a representation (e.g., a downscaled representation) of the image frame. The second stage is configured to process the first stage output (e.g., the image latent data) to generate second stage output corresponding to a representation (e.g., an additionally downscaled representation) of the image frame.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1A, a particular illustrative aspect of a system configured to perform hierarchical vision encoding enabled cognition analysis based on image-feature group (IFG) identifiers is disclosed and generally designated 100. The system 100 includes a device 102 that includes one or more processors 190 coupled to a memory 132. The one or more processors 190 are also coupled to an image source 106. The one or more processors 190 include a hierarchical vision encoder (HVE) 180, a latent-to-IFG (L2I) resolver, an IFG-to-latent (I2L) resolver 144, and an image-based cognitive analyzer 146. The HVE 180 is coupled to the memory 132. The memory 132 is also coupled, via the I2L resolver 144, to the image-based cognitive analyzer 146.

The image source 106 is depicted as a video camera external to the device 102 as an illustrative example, in some other examples, the image source 106 can be integrated into the device 102. In some examples, the image source 106 can include various types of image sources, such as a still camera, a synthetic image generation device (e.g., a graphical processing unit (GPU)), a network device, a storage device, a communication device, or a combination thereof. The image source 106 is configured to provide a sequence of image frames 112 to the one or more processors 190. In a particular aspect, the sequence of image frames 112 includes an image frame 112A, an image frame 112B, one or more additional image frames, or a combination thereof.

The HVE 180 is configured to process an image frame 112 to generate image latent data 122 that corresponds to a downscaled representation of the image frame 112, as further described with reference to FIG. 1B. In an example, the HVE 180 includes a plurality of stages 140. An initial stage 140 is configured to process an image frame 112 to generate image latent data corresponding to a downscaled representation of the image frame 112. Each subsequent stage 140 is configured to process previous image latent data generated by a prior stage 140 to generate subsequent image latent data. The previous image latent data corresponds to a representation of a previous image frame (e.g., a downscaled version of the image frame 112) and the subsequent image latent data corresponds to a downscaled representation of the previous image frame (e.g., an additionally downscaled version of the image frame 112). A last stage 140 is configured to process image latent data generated by a prior stage 140 to generate the image latent data 122. Optionally, in some embodiments, the HVE 180 includes a convolutional neural network (CNN), and a particular convolutional layer of the CNN corresponds to a respective stage 140 of the HVE 180.

The L2I resolver 142 is configured to determine image-feature group (IFG) identifiers 124 that are associated with image latent data 122. Optionally, in some embodiments, the L2I resolver 142 includes IFG mapping data (e.g., cluster data) that can be used to map the image latent data 122 to IFG identifiers 124 (e.g., cluster identifiers), as described herein. In some examples, the IFG mapping data includes a codebook (CB) 134. To illustrate, the L2I resolver 142 is configured to map the image latent data 122 in a continuous space to IFG identifiers 124 in a discrete space. In some aspects the L2I resolver 142 corresponds to a dictionary mapping that includes a CB 134 that can be used to map image latent data 122 to codebook indices 170 as IFG identifiers 124, as described herein. It should be understood that codebook indices and cluster identifiers are provided as illustrative examples of IFG identifiers 124, in other examples other types of IFG identifiers 124 can be used, such as bin identifiers.

The I2L resolver 144 is configured to determine IFG latent data 126 that is associated with an IFG identifier 124. For example, in some embodiments, the I2L resolver 144 uses the IFG mapping data (e.g., the CB 134) to map a codebook index 170 to a codebook entry (e.g., a codebook feature embedding 174) as IFG latent data 126, as described herein. To illustrate, the I2L resolver 144 is configured to map IFG identifiers 124 in a discrete space to the IFG latent data 126 in a continuous space. In some examples, the I2L resolver 144 uses IFG mapping data (e.g., cluster data) to map a cluster identifier to a cluster mean as IFG latent data 126, as described herein. It should be understood that codebook entries and cluster means are provided as illustrative examples of IFG latent data 126, in other examples other types of IFG latent data 126 can be used, such as a bin value, a prototype feature, a medoid feature, or a combination thereof.

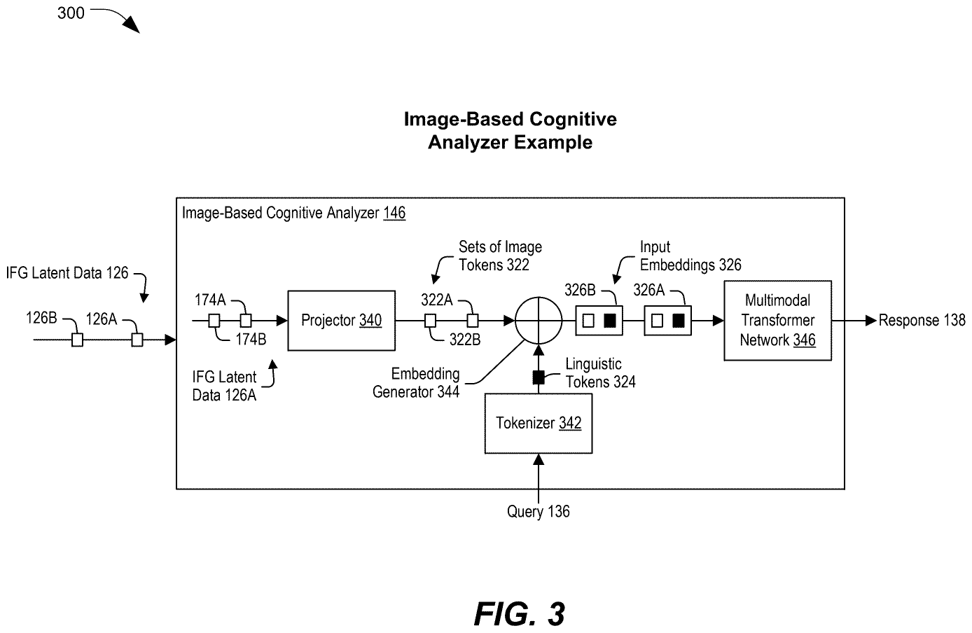

The image-based cognitive analyzer 146 is configured to use IFG latent data 126 to perform image-based cognitive analysis. For example, the image-based cognitive analyzer 146 is configured to process IFG latent data 126 of one or more image frames 112 to generate a response 138 to a query 136, as further described with reference to FIG. 3. To illustrate, the image-based cognitive analyzer 146 is configured to generate image tokens based on the IFG latent data 126, generate linguistic tokens based on the query 136, generate an input embedding based on the image tokens and the linguistic tokens, and use a large language model (LLM) to process the input embedding to generate the response 138.

The memory 132 is configured to store data used or generated by one or more components of the device 102. For example, the memory 132 is configured to store one or more of an image frame 112, image latent data 122 corresponding to a representation (e.g., a downscaled representation) of the image frame 112, a set of IFG identifiers 124 corresponding to the image latent data 122, image analysis data 148 used to represent the sequence of image frames 112 for image-based cognitive analysis, IFG latent data 126 corresponding to the set of IFG identifiers 124, the query 136, the response 138, or additional data. In some aspects, the memory 132 includes an image buffer, a data transmission buffer, a data receipt buffer, or a combination thereof. The set of IFG identifiers 124 represents the image frames 112. In some examples, an image frame 112 can depict sensitive information, people, homes, offices, etc., and storing or transmitting the set of IFG identifiers 124 instead of the image frames 112 enhances security.

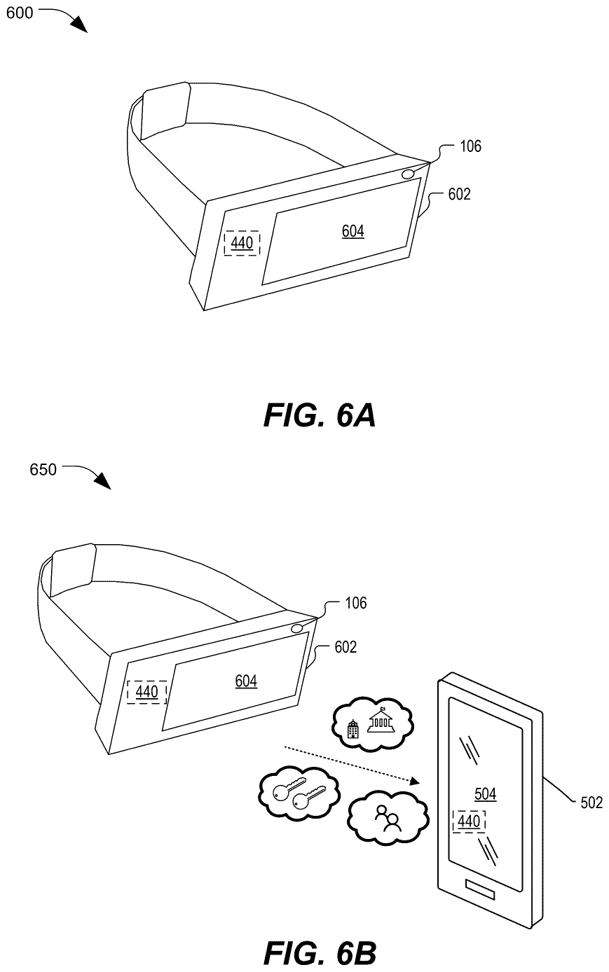

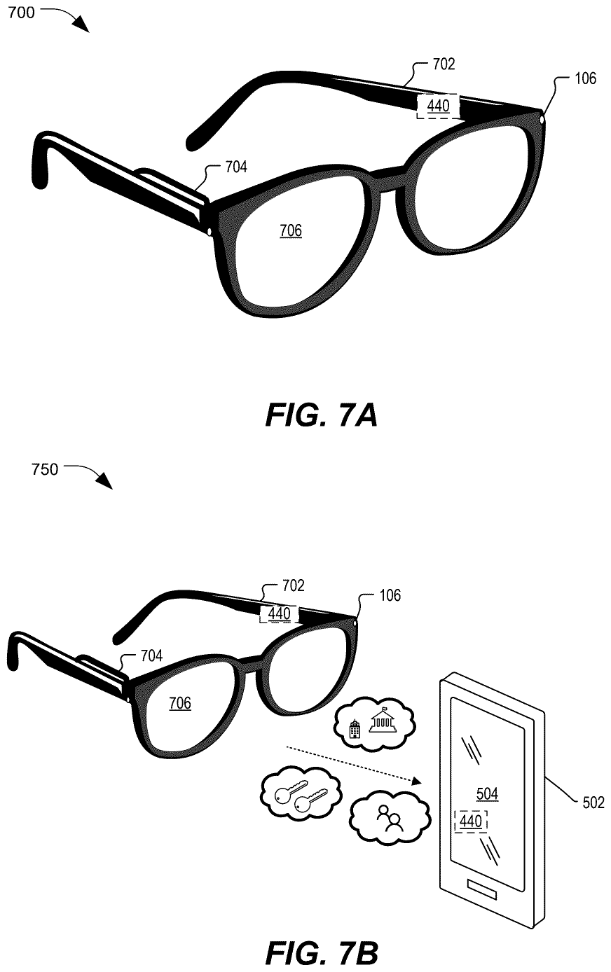

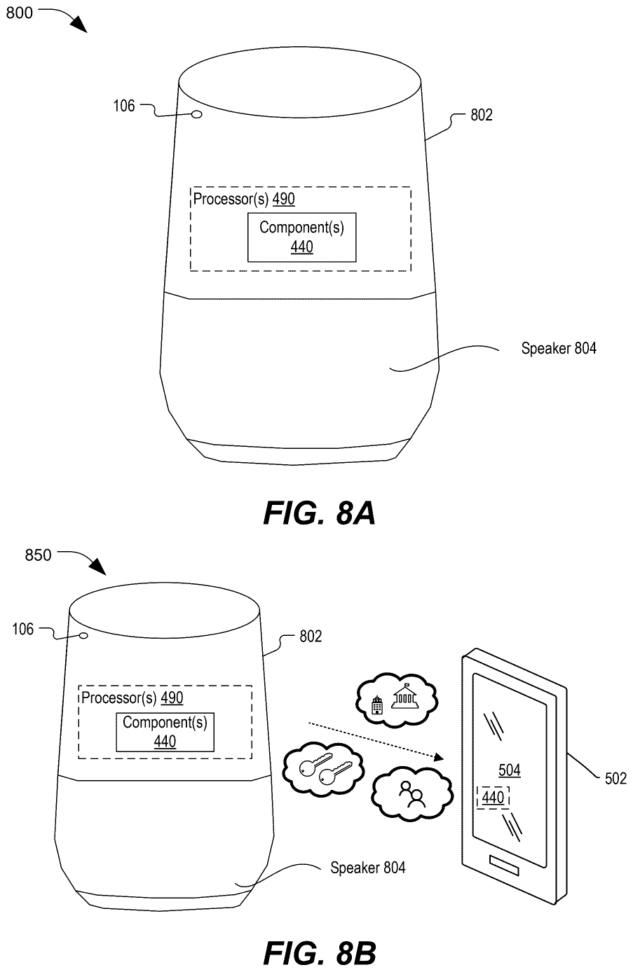

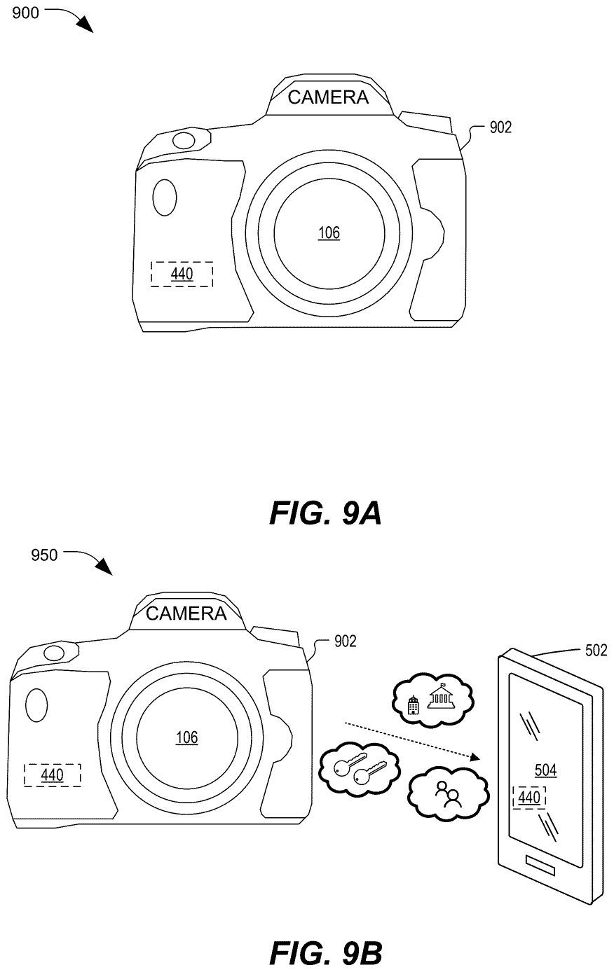

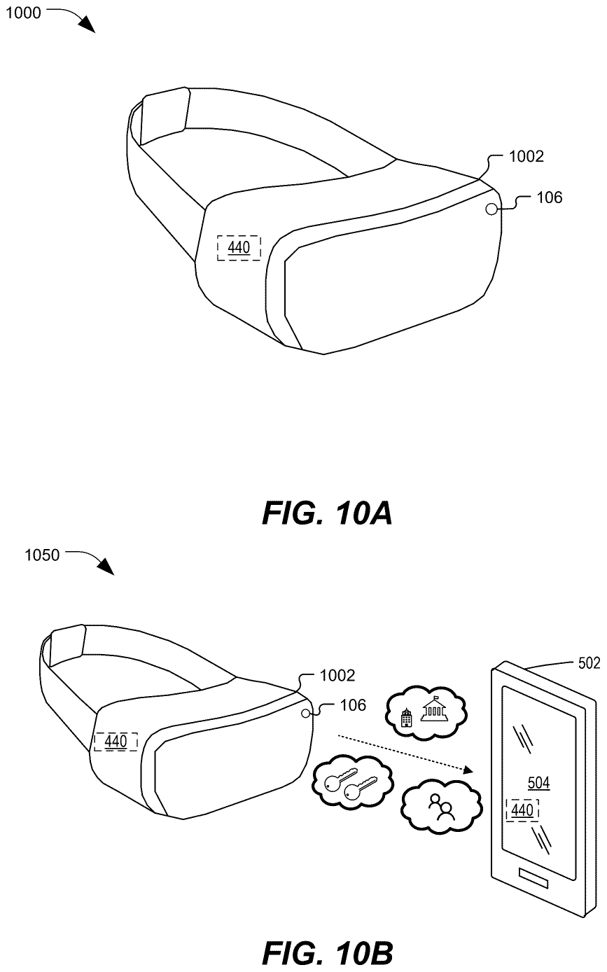

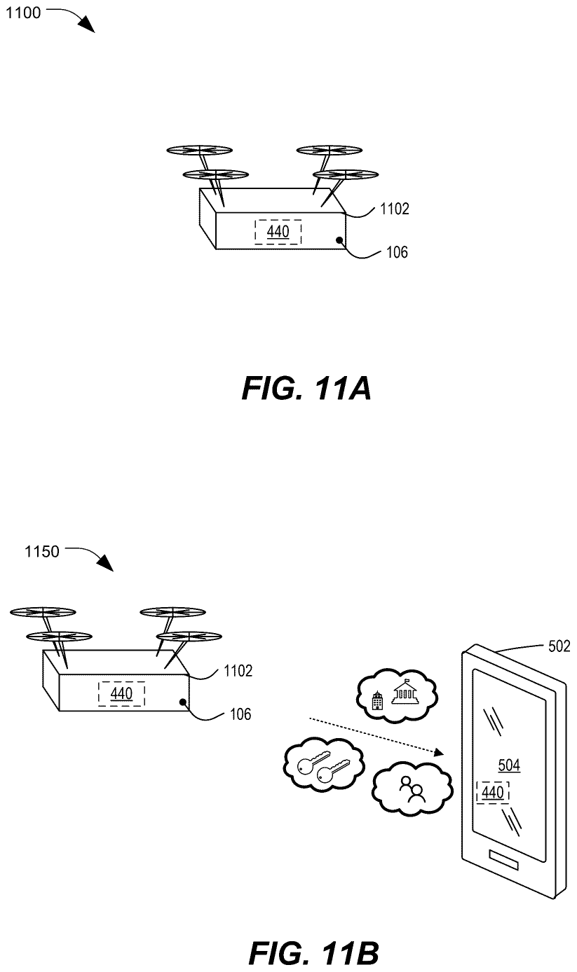

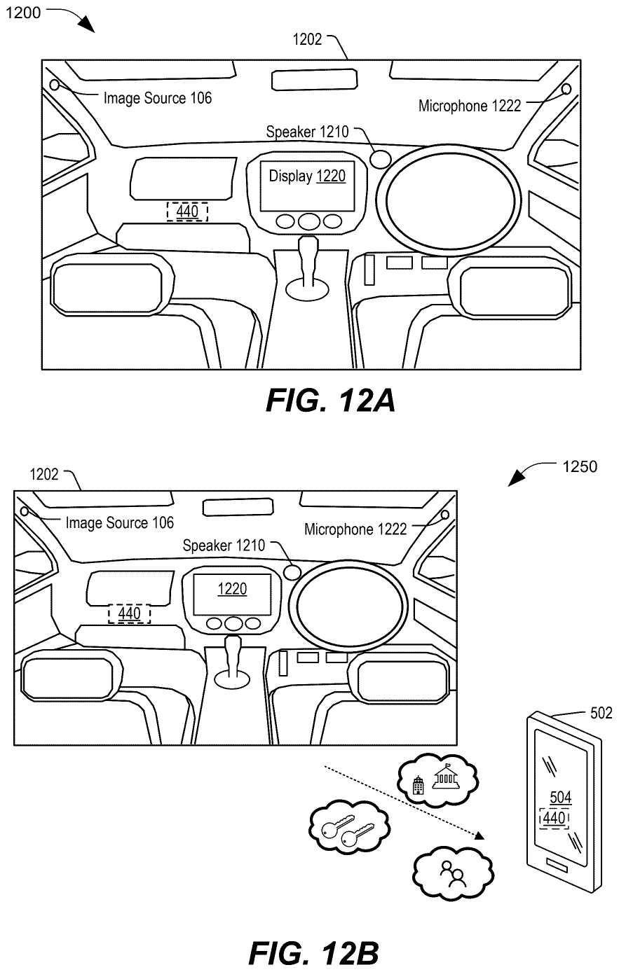

In some embodiments, the device 102 corresponds to or is included in one of various types of devices. In an illustrative example, the one or more processors 190 are integrated in at least one of a mobile phone or a tablet computer device, as described with reference to FIG. 5, a wearable electronic device, as described with reference to FIG. 6A, a mixed reality or augmented reality glasses device, as described with reference to FIG. 7A, a voice-controlled speaker system, as described with reference to FIG. 8A, a camera device, as described with reference to FIG. 9A, or a virtual reality, mixed reality, or augmented reality headset, as described with reference to FIG. 10A. In another illustrative example, the one or more processors 190 are integrated into a vehicle, such as described further with reference to FIG. 11A and FIG. 12A.

During operation, the image source 106 (e.g., a phone camera) of a user 101 provides an image frame 112A of a sequence of image frames 112 to the HVE 180. The HVE 180, using the stages 140, processes the image frame 112A to generate image latent data 122A corresponding to a representation (e.g., a downscaled representation) of the image frame 112A, as further described with reference to FIG. 1B. In some aspects, the image latent data 122A includes a plurality of image feature embeddings 152 that correspond to the downscaled representation of the image frame 112A. Optionally, in some embodiments, the HVE 180, subsequent to processing the image frame 112A to generate the image latent data 122A, discards the image frame 112A. To illustrate, the image frame 112A is stored in the memory 132 (e.g., an image buffer) and the HVE 180 marks the image frame 112A for deletion from the memory 132.

Optionally, in some embodiments, the HVE 180 includes a CNN that includes one or more convolutional layers (e.g., 5 convolutional layers), one or more pooling layers, one or more fully connected layers, a softmax layer, or a combination thereof. As one example, the image frame 112A can include data representing a set of pixels (e.g., 768×768 pixels), where each pixel represents multiple color channels, such as red, green, blue (RGB). In this example, the image frame 112A can be processed using the CNN of the HVE 180 to generate the image latent data 122A. The image latent data 122A can include a set of image feature embeddings (e.g., 144 image feature embeddings), where each image feature embedding includes a vector or array of values (e.g., a 512-dimensional feature vector). In some examples, one or more layers (e.g., convolutional layers) of the CNN correspond to downscaling operations (e.g., downscaling stages 140), and the image latent data 122A corresponds to a downscaled representation of the image frame 112A. It should be understood that a CNN is provided as an illustrative example of the HVE 180, in other examples the HVE 180 can include other types of neural networks, procedural operations, or a combination thereof, to generate the image latent data 122A that corresponds to a representation (e.g., a downscaled representation) of the image frame 112A.

The L2I resolver 142 processes the image latent data 122A to generate a set of IFG identifiers 124A. For example, the L2I resolver 142 uses IFG mapping data to map the image latent data 122A to the set of IFG identifiers 124A. Optionally, the L2I resolver 142, subsequent to processing the image latent data 122A to generate the set of IFG identifiers 124A, discards the image latent data 122A. To illustrate, the image latent data 122A is stored in the memory 132 (e.g., a latent data buffer), and the L2I resolver 142 marks the image latent data 122A for deletion from the memory 132.

In an example 190, the L2I resolver 142 uses a CB 134 as a dictionary mapping to map image latent data 122 to a set of IFG identifiers 124. The CB 134 includes a plurality of CB feature embeddings 174. As one example, the CB 134 includes a set of CB feature embeddings 174 (e.g., 4096 feature embeddings), where each CB feature embedding includes a vector or array of values (e.g., a 512-dimensional feature vector). Each CB feature embedding 174 of the CB 134 is associated with a respective CB index 170. For example, CB indices have a range (e.g., 0 to 4095), with each CB index having a size (e.g., 2-bytes) that can represent values in the range. In an example, the CB 134 includes a CB feature embedding (FE) 174A, a CB FE 174B, and a CB FE 174C associated with a CB index (CBI) 170A, a CBI 170B, and a CBI 170C, respectively. The CB 134 including three CB FEs 174 is provided as an illustrative example, in other examples the CB 134 can include fewer than three or more than three CB FEs 174.

Each CB FE 174 can be considered a representative value of a respective IFG. In some aspects, a group of image feature embeddings can map to (e.g., are nearest neighbors of) a particular CB FE 174. For example, each of a first group of image feature embeddings maps to (e.g., are nearest neighbors of) the CB FE 174A, each of a second group of image feature embeddings maps to the CB FE 174B, each of a third group of image feature embeddings maps to the CB FE 174C, and so on.

The image latent data 122A includes a plurality of image feature embeddings, such as an image FE 152A, an image FE 152B, one or more additional image FEs, or a combination thereof. The L2I resolver 142, based on determining that the image feature embedding 152A maps to (e.g., is a nearest neighbor of) the CB FE 174A, adds the CBI 170A of the CB FE 174A to a set of IFG identifiers 124A associated with the image frame 112A. Similarly, the L2I resolver 142, based on determining that the image feature embedding 152B maps to the CB FE 174C, adds the CBI 170C of the CB FE 174C to the set of IFG identifiers 124A. The set of IFG identifiers 124A thus includes a set of codebook indices 170 of a plurality of codebook feature embeddings 174 that match the plurality of image feature embeddings 152 of the image latent data 122A. It should be understood that the CB 134 is provided as an illustrative example of IFG mapping data that can be used to map image latent data 122 (e.g., an image feature embedding 152) to an IFG identifier (e.g., a CBI 170). In other examples, various types of IFG resolution data can be used to resolve image latent data 122 to an IFG identifier. To illustrate, image feature embedding cluster data can be used to map an image feature embedding 152 to a cluster identifier as an IFG identifier 124.

The L2I resolver 142 adds the set of IFG identifiers 124A to image analysis data 148 used to represent the sequence of image frames for image-based cognitive analysis. In an example, the set of IFG identifiers 124A includes a set of CBIs 170 (e.g., 144 CBIs). In a particular aspect, the set of IFG identifiers 124A is designated as associated with (e.g., representative of) the image frame 112A. In an example, the set of IFG identifiers 124A is designated as associated with a timestamp of the image frame 112A, a location of the image source 106 when the image frame 112A is captured, a user identifier of a user 101 that is logged into the device 102 when the image frame 112A is obtained, or a combination thereof. The image analysis data 148 is stored in the memory 132.

In some aspects, the HVE 180 and the L2I resolver 142 perform similar operations to process additional image frames of the sequence of image frames 112 to generate corresponding sets of IFG identifiers 124. For example, the HVE 180 obtains the image frame 112B from the image source 106 and processes the image frame 112B to generate image latent data 122B, and the L2I resolver 142 processes the image latent data 122B to generate the set of IFG identifiers 124B. Optionally, in some embodiments, the HVE 180, subsequent to processing the image frame 112B to generate the image latent data 122B, discards the image frame 112B.

Optionally, in some embodiments, the HVE 180 and the L2I resolver 142 selectively process the image frame 112B to generate the set of IFG identifiers 124B. For example, the HVE 180, based on a comparison of the image frame 112A and the image frame 112B, determines whether to process the image frame 112B. To illustrate, the HVE 180, based on determining that differences between the image frame 112A and the image frame 112B fail to satisfy a difference threshold, refrains from processing the image frame 112B and discards the image frame 112B. Alternatively, the HVE 180, based on determining that the differences between the image frame 112A and the image frame 112B satisfy the difference threshold, processes the image frame 112B to generate the image latent data 122B. Optionally, the HVE 180, subsequent to processing the image frame 112B to generate the image latent data 122B, discards the image frame 112B.

In some examples, the L2I resolver 142 selectively processes the image latent data 122B to generate the set of IFG identifiers 124B. For example, the L2I resolver 142, based on a comparison of the image latent data 122A and the image latent data 122B, determines whether to process the image latent data 122B. To illustrate, the L2I resolver 142, based on determining that differences between the image latent data 122A and the image latent data 122B fail to satisfy a difference threshold, refrains from processing the image latent data 122B and discards the image latent data 122B. Alternatively, the L2I resolver 142, based on determining that the differences between the image latent data 122A and the image latent data 122B satisfy the difference threshold, processes the image latent data 122B to generate the set of IFG identifiers 124B. Optionally, the L2I resolver 142, subsequent to processing the image latent data 122B to generate the set of IFG identifiers 124B, discards the image latent data 122B. The L2I resolver 142 adds the set of IFG identifiers 124B to the image analysis data 148.

A set of IFG identifiers 124 is smaller than a corresponding image frame 112. For example, the set of IFG identifiers 124A has a first size that is smaller than a second size of the image frame 112A. In an example, the set of IFG identifiers 124A includes a set of CBIs 170 and the image frame 112A includes a set of pixels. In this example, the set of IFG identifiers 124A has a first size that is based on the count of CBIs and a CBI size, and the image frame 112A has a second size that is based on a count of pixels and a pixel size. To illustrate, the first size (e.g., 288 bytes)=CBI count (e.g., 144 CBIs)×CBI size (e.g., 2 bytes). The second size (e.g., 1,769,472 bytes or 1.69 megabytes (MB))=pixel count (e.g., 768×768 pixels=589,824 pixels)×pixel size (e.g., 3 bytes/pixel). Hence, a count of bits (e.g., 288 bytes) used to store the set of IFG identifiers 124A in the memory 132 is less than a count of bits (e.g., 1.69 MB) that would be used to store the image frame 112A in the memory 132.

It should be understood that particular values are provided as illustrative examples, in some other examples other values can be used. For example, 3 bytes/pixel is used as an illustrative example of pixel size (e.g., an RGB pixel size of 3 bytes), in some other examples a pixel can have another size. As another example, particular dimensions (e.g., 768×768 pixels) of an image frame are used as an illustrative example, in some other examples an image frame can have other dimensions. A particular CBI count (e.g., 144 CBIs) is provided as an illustrative example, in some other examples the set of IFG identifiers 124A can include another count of CBIs.

A video with a particular frame rate typically has a corresponding count of image frames 112 in an hour of video. For example, an hour of video with a particular frame rate (e.g., 1 frame/second) corresponds to an hourly image frame count (e.g., 1 frame/second×3600 seconds/hour=3600 frames/hour). The sets of IFG identifiers 124 corresponding to an hour of video have an hourly set size that is based on the hourly image frame count and a size of a set of IFG identifiers 124 of an image frame 112. For example, the hourly set size (e.g., 1,036,800 bytes/hour≈0.00097 gigabytes (GB)/hour)=hourly image frame count (e.g., 3600 image frames/hour)×IFG identifier set size (e.g., 288 bytes/image frame). With a pre-determined memory capacity to store the image analysis data 148, sets of IFG identifiers 124 of a video having up to a particular length can be stored. The particular length is based on the memory capacity and the hourly set size. For example, particular length (e.g., 4123.71 hours)=memory capacity (e.g., 4 GB)÷hourly set size (e.g., 0.00097 GB/hour). In some examples, the HVE 180 or the L2I resolver 142 may selectively refrain from generating a set of IFG identifiers 124 of an image frame 112. In these examples, sets of IFG identifiers 124 of a video having a longer duration than the particular length (e.g., 4123.71 hours) can be stored.

Subsequently, the image-based cognitive analyzer 146 receives a query 136 related to the sequence of image frames 112. In a particular aspect, the image-based cognitive analyzer 146 receives, from a user 101, user input 172 indicating the query 136. In some aspects, the query 136 indicates a set of image frames 112 of interest. For example, the query 136 (e.g., “where did I leave my keys in the last one hour?”) indicates a target time interval (e.g., captured in the last one hour) of the set of image frames 112 of interest. The image-based cognitive analyzer 146, based on determining that the query 136 is associated with one or more image frames 112, requests latent data from the I2L resolver 144 corresponding to the one or more image frames 112. For example, the image-based cognitive analyzer 146, based on determining that query 136 is associated with the image frame 112A, requests latent data from the I2L resolver 144 corresponding to the image frame 112A.

The I2L resolver 144, based on receiving the request from the image-based cognitive analyzer 146, retrieves the set of IFG identifiers 124A corresponding to the image frame 112A from the image analysis data 148. The I2L resolver 144 uses IFG mapping data to determine IFG latent data 126A corresponding to the set of IFG identifiers 124A associated with the image frame 112A. For example, the I2L resolver 144, in response to determining that the set of IFG identifiers 124A includes the CBI 170A, retrieves the CB FE 174A that corresponds to the CBI 170A from the CB 134 and adds the CB FE 174A to IFG latent data 126A. As another example, the I2L resolver 144, in response to determining that the set of IFG identifiers 124A includes the CBI 170C, retrieves the CB FE 174C from the CB 134 and adds the CB FE 174C to the IFG latent data 126A. The CB 134 is provided as an illustrative example of IFG mapping data used to map the set of IFG identifiers 124A to the IFG latent data 126A, in other examples other types of IFG mapping data (e.g., image feature embedding cluster data) can be used to map the set of IFG identifiers 124A to the IFG latent data 126A. The I2L resolver 144 provides the IFG latent data 126A to the image-based cognitive analyzer 146.

The image-based cognitive analyzer 146 performs image-based cognitive analysis based on the IFG latent data 126A to generate a response 138 to the query 136, as further described with reference to FIG. 3. The image-based cognitive analysis includes processing linguistic inputs and image-based inputs using a multimodal transformer network. For example, the image-based cognitive analyzer 146 generates image tokens based on the IFG latent data 126A and linguistic tokens based on the query 136, generates an input embedding based on the image tokens and the linguistic tokens, uses a multimodal transformer network (e.g., an LLM) to perform image-based cognitive analysis based on the input embedding to generate the response 138. The response 138 can include text, audio, or both. If the response 138 corresponds to an answer to the query 136 that is identified in the image frame 112A, the response 138 can indicate image-related data associated with the set of IFG identifiers 124A. For example, if the response 138 indicates that a queried object (e.g., the key) was most recently detected in the image frame 112A, the response 138 can indicate a time, a location, a user, or a combination thereof associated with the set of IFG identifiers 124A. In a particular aspect, the image-based cognitive analyzer 146 outputs the response 138 to the user 101. In an example, the image-based cognitive analyzer 146 provides the response 138 to a display device, a communication device, a speaker, or a combination thereof.

A technical advantage of the system 100 includes accessibility to data associated with more image frames 112 for cognitive analysis. For example, the set of IFG identifiers 124A is smaller than the image frame 112A. With limited storage capacity, sets of IFG identifiers 124 corresponding to more image frames 112 can be stored in the memory 132 than original image frames 112.

Another technical advantage of the system 100 includes enhanced security. For example, the set of IFG identifiers is not useable to generate an accurate reproduction of the image frame. To illustrate, because the set of IFG identifiers 124A represents the IFG latent data 126A that is an approximation of the image latent data 122 and also because the image latent data 122 corresponds to a downsampled representation of the image frame 112A, the set of IFG identifiers 124A that is stored in the memory 132 cannot typically be used to generate an accurate reproduction of the image frame 112A.

In some examples, based on an output of the HVE 108, the image-based cognitive analyzer 146, a neural network, a machine-learning model, or a combination thereof, one or more components of a device (e.g., the device 102) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as field-programmable gate array (FPGA), a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 1B, an illustrative example of the HVE 180 is disclosed, in accordance with some examples of the present disclosure. The HVE 180 includes a plurality of stages 140, such as a stage 140A, a stage 140B, one or more additional stages 140, a stage 140Y, or a combination thereof. It should be understood that the HVE 180 is depicted as including 3 stages 140 as an illustrative example; in other examples the HVE 180 can include fewer than 3 or more than 3 stages 140.

Each stage 140 of the HVE 180 includes a multi-context local attention 160. For example, the stage 140A includes a multi-context local attention 160A, the stage 140B includes a multi-context local attention 160B, the stage 140Y includes a multi-context local attention 160Y, and so on. One or more of the stages 140 of the HVE 180 include a downscaling layer 162 (e.g., a pooling layer or a convolution layer). For example, the stage 140A includes a downscaling layer 162A, the stage 140B includes a downscaling layer 162B, and so on. In some embodiments, the last stage (e.g., the stage 140Y) does not include a downscaling layer 162.

The multi-context local attention 160A processes data representing an image frame 112 to generate image latent data 164A. In an example, a multi-context local attention 160 is configured to capture dependencies across different parts of an input. To illustrate, the multi-context local attention 160 performs feature extraction by integrating contextual information to generate image latent data 164.

The image frame 112 has a height (H), a width (W), and channels (C). The image latent data 164A includes first image feature embeddings representing the image frame 112 having the height (H) and the width (W). An image feature embedding has an embedding dimension (D) that indicates a count of features (e.g., numerical values) represented in the image feature embedding.

The downscaling layer 162A processes the image latent data 164A to generate image latent data 166A. The image latent data 166A includes second image feature embeddings that represent a downscaled representation of the image frame 112. For example, the downscaled representation has a height (H/r) and a width (W/r), where r corresponds to a downscaling factor. In some embodiments, a second image feature embedding of image latent data 166 has the same dimensionality (D) as a first image feature embedding of image latent data 164. In some embodiments, a count of the second image feature embeddings included in the image latent data 166 that is output by a downscaling layer 162 is fewer than a count of the first image feature embeddings included in the image latent data 164 input to the downscaling layer 162.

Optionally, in some embodiments, similar operations are performed at one or more intermediate stages 140 of the HVE 180 based on output of respective previous stages 140. For example, the multi-context local attention 160B processes the image latent data 166A to generate image latent data 164B. The downscaling layer 162B processes the image latent data 164B to generate image latent data 166B. The image latent data 166B includes third image feature embeddings that represent a downscaled representation of the image frame 112. For example, the downscaled representation has a height (H/r²) and a width (W/r²), where each of the downscaling layers 162A and 162B have the same downscaling factor (r). To illustrate, the third image feature embeddings of the image latent data 166B correspond to a downscaled representation of an image frame represented by the second image frame embeddings of the image latent data 166A. In some embodiments, a count of the third image feature embeddings included in the image latent data 166B that is output by the downscaling layer 162B is fewer than a count of the second image feature embeddings included in the image latent data 166A that is output by the downscaling layer 162A.

At the stage 140Y (e.g., a last stage of the stages 140), the multi-context local attention 160B processes the image latent data 166X (e.g., image latent data 166 generated by a previous stage 140) to generate the image latent data 122. The image latent data 122 corresponds to a downscaled representation of the image frame 112. In some aspects, the downscaled representation has a height (H/r^{x}) and a width (W/r^{x}), where x is a count of stages prior to the stage 140Y. In an example, the image latent data 122 includes fourth image feature embeddings, and each image feature embedding has an embedding dimension (D). In some aspects, a count of the fourth image feature embeddings of the image latent data 122 is fewer than a count of the first image feature embeddings of the image latent data 164A. For example, the fourth image feature embeddings correspond to a downscaled representation (e.g., an image frame having a height (H/r^{x}) and a width (W/r^{x})) as compared to the first image frame embeddings corresponding to the image frame 112 (e.g., having a height (H) and a width (W)).

It should be understood that a stage 140 can include one or more additional layers or components that are not shown, such as one or more of a normalization layer, a convolution layer, a pooling layer, etc. In an example 182, various types of normalizations are depicted, such as batch normalization, layer normalization, instance normalization, and group normalization. Height (H) and width (W) correspond to spatial dimensions of an image frame 112, C corresponds to channels in the image frame 112, and N corresponds to a batch size.

A technical advantage of the HVE 180 includes retaining characteristics of the image frames 112 in the image latent data 122 with a reduced size, as compared to the original image frame 112 and also as compared to the image latent data 164A. The smaller size of the image latent data 122 enables conservation of resources (e.g., memory, bandwidth, or both).

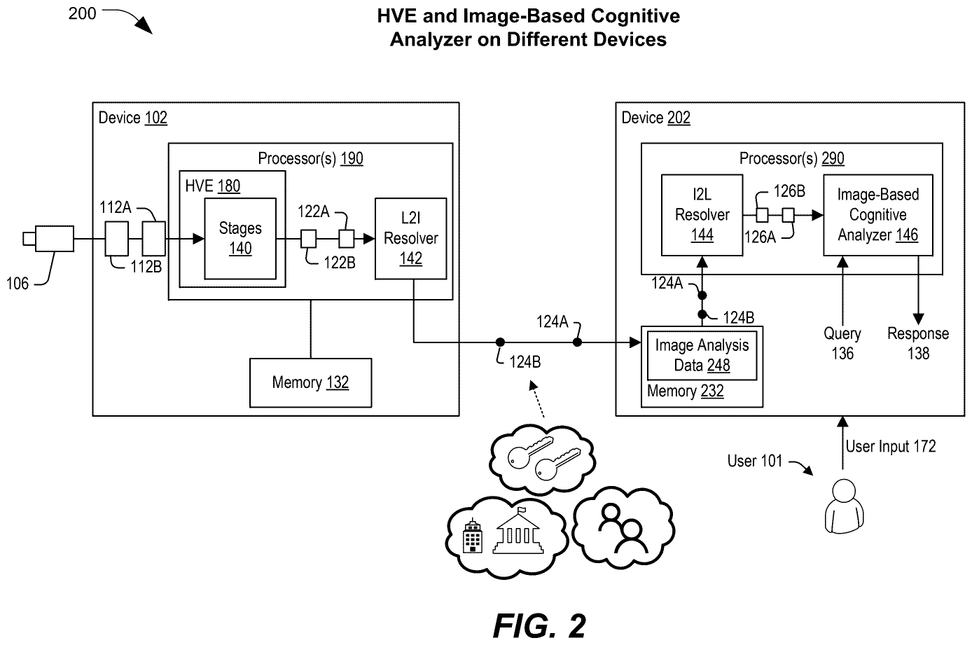

Referring to FIG. 2, a particular illustrative aspect of a system configured to perform hierarchical vision encoding enabled cognitive analysis is disclosed and generally designated 200, in accordance with some examples of the present disclosure. The system 200 includes the device 102 coupled to one or more devices 202.

A device 202 includes one or more processors 290 coupled to a memory 232. The memory 232 is configured to store data used or generated by one or more components of the device 202. The I2L resolver 144 and the image-based cognitive analyzer 146 are included in the one or more processors 290 of the device 202. The HVE 180 and the L2I resolver 142 are included in the one or more processors 190 of the device 102. In a non-limiting illustrative example, the device 102 can correspond to extended reality (XR) glasses and the device 202 can correspond to a companion device (e.g., a phone, a gaming system, a network device, a server, or a combination thereof) that has more storage capacity.

During operation, the HVE 180 and the L2I resolver 142 process the image frame 112A to generate the set of IFG identifiers 124A, as described with reference to FIG. 1A. The L2I resolver 142 adds the set of IFG identifiers 124A to image analysis data 248 used to represent the sequence of image frames 112 for image-based cognitive analysis. For example, the L2I resolver 142 initiates transmission of the set of IFG identifiers 124A to one or more devices 202.

The device 202 receives the set of IFG identifiers 124A and adds the set of IFG identifiers 124A to the image analysis data 248 stored in the memory 232. Subsequently, the I2L resolver 144 of the device 202 retrieves the set of IFG identifiers 124A from the memory 232, determines the IFG latent data 126A corresponding to the set of IFG identifiers 124A, and provides the IFG latent data 126A to the image-based cognitive analyzer 146. The image-based cognitive analyzer 146 processes the IFG latent data 126A to generate the response 138 to the query 136, as described with reference to FIGS. 1A and 3. For example, the image-based cognitive analyzer 146 generates image tokens based on the IFG latent data 126A, generates linguistic tokens based on the query 136, and uses an LLM to perform image-based cognitive analysis based on the image tokens and the linguistic tokens to generate the response 138.

A technical advantage of the system 200 includes offloading storage of the sets of IFG identifiers 124 and performance of the image-based cognitive analysis from the device 102 (e.g., XR glasses) to the device 202 (e.g., a companion device). Hence, the device 102 can be a relatively light-weight device, with the device 202 having more resources (e.g., more memory, computing resources, or both).

In some examples, an image frame 112 can depict sensitive information, people, homes, offices, etc. Because the image frame 112A can typically not be accurately reproduced from the set of IFG identifiers 124A, transmitting the set of IFG identifiers 124A to the device 202 maintains security.

In some examples, based on an output of the HVE 108, the image-based cognitive analyzer 146, a neural network, a machine-learning model, or a combination thereof, one or more components of a device (e.g., the device 102, the device 202, or both) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as FPGA, a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 3, an illustrative example 300 of the image-based cognitive analyzer 146 is disclosed, in accordance with some examples of the present disclosure. The image-based cognitive analyzer 146 includes a projector 340 and a tokenizer 342 that are each coupled to an embedding generator 344. The embedding generator 344 is coupled to a multimodal transformer network 346. In some aspects, the multimodal transformer network 346 corresponds to (e.g., includes) an LLM. In a particular aspect, the image-based cognitive analyzer 146 can be included in the device 102 of FIG. 1A, the device 202 of FIG. 2, or both.

During operation, the tokenizer 342 processes the query 136 to generate linguistic tokens 324 that represent the query 136 in a token space. In an example, the tokenizer 342 breaks up the query 136 into linguistic segments, such as subwords, words, characters, other types of segments, or a combination thereof. The tokenizer 342 outputs linguistic tokens 324 (e.g., numerical values) corresponding to the linguistic segments. To illustrate, a linguistic token 324 (e.g., a numerical value) represents a corresponding linguistic segment in the token space.

The image-based cognitive analyzer 146 receives the IFG latent data 126A corresponding to the image frame 112A, as described with reference to FIGS. 1A and 2. In an example, the IFG latent data 126A includes the CB FE 174A, the CB FE 174B, one or more additional CB FEs, or a combination thereof, as described with reference to FIG. 1A. The projector 340 processes each CB FE 174 to generate a corresponding set of image tokens 322. For example, the projector 340 processes the CB FE 174A to generate a set of image tokens 322A, the CB FE 174B to generate a set of image tokens 322B, and so on. A set of image tokens 322 represents a corresponding CB FE 174 in a token space. In a particular aspect, the set of image tokens 322A and the linguistic tokens 324 are associated with the same token space and can be processed together by the multimodal transformer network 346.

The embedding generator 344 generates an input embedding 326A based on the set of image tokens 322A and the linguistic tokens 324. For example, the embedding generator 344 concatenates the set of image tokens 322A and the linguistic tokens 324 to generate the input embedding 326A. The multimodal transformer network 346 processes the input embedding 326A to generate the response 138. In a particular aspect, the response 138 includes a synthetic image, text, audio, or a combination thereof.

Similarly, the image-based cognitive analyzer 146 processes one or more additional CB FEs 174 of the IFG latent data 126A associated with the image frame 112A and continues to generate (e.g., update) the response 138. For example, the projector 340 processes the CB FE 174B to generate a set of image tokens 322B. The embedding generator 344 generates an input embedding 326B based on the set of image tokens 322B and the linguistic tokens 324. The multimodal transformer network 346 is configured to perform image-based cognitive analysis based on image tokens and linguistic tokens. For example, the multimodal transformer network 346 processes the input embedding 326B to generate (e.g., update) the response 138.

In a particular aspect, the image-based cognitive analyzer 146 processes IFG latent data 126 corresponding to one or more additional image frames 112 and continues to generate (e.g., update) the response 138. For example, the image-based cognitive analyzer 146 processes the IFG latent data 126B corresponding to the image frame 112B to generate (e.g., update) the response 138.

A technical advantage of the image-based cognitive analyzer 146 includes enabling generation of a response 138 to the query 136 based on the IFG latent data 126 that represents an approximation of image features of downsampled representations of the image frames 112 without having access to the original image frames 112. For example, the HVE 180 and the L2I resolver 142 of FIGS. 1A-2 can process an image frame 112A to generate the set of IFG identifiers 124A and the image frame 112A can be discarded. The set of IFG identifiers 124A can be used to generate the IFG latent data 126A that is used to generate the response 138. Using the set of IFG identifiers 124A instead of the original image frame 112A can conserve resources (e.g., bandwidth, memory, or both) and enhance security, as described with reference to FIGS. 1A and 2.

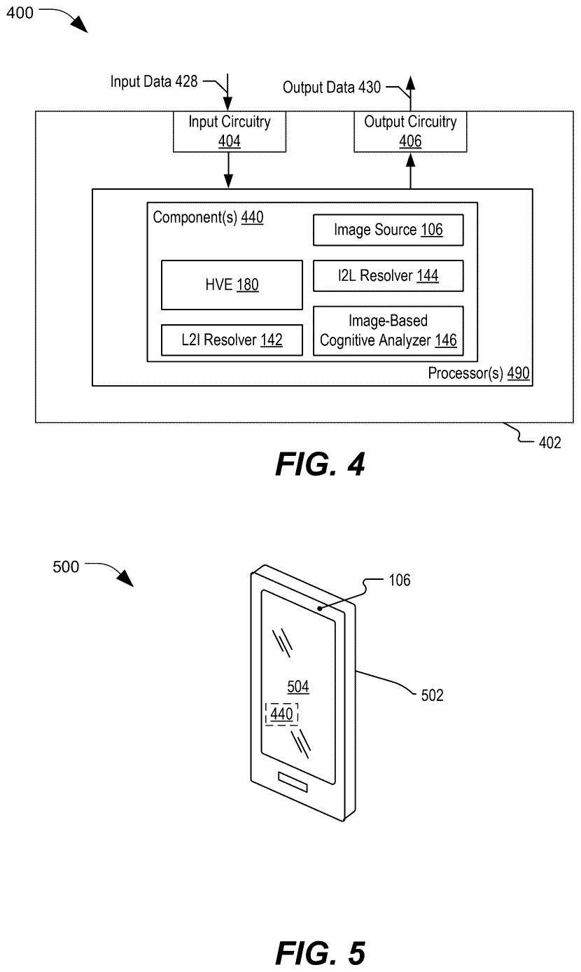

FIG. 4 depicts an implementation 400 of an integrated circuit 402 that includes one or more processors 490. In a particular aspect, the integrated circuit 402 corresponds to an implementation of the device 102, the device 202, or both.

The one or more processors 490 include one or more components 440, such as the image source 106, the HVE 180, the L2I resolver 142, the I2L resolver 144, the image-based cognitive analyzer 146, or a combination thereof. In a particular aspect, the image-based cognitive analyzer 146 includes the projector 340, the tokenizer 342, the embedding generator 344, the multimodal transformer network 346, or a combination thereof.

The integrated circuit 402 also includes input circuitry 404, such as one or more bus interfaces, to enable input data 428 to be received for processing. In a particular aspect, the input data 428 includes data used by one or more of the components 440, as described herein. For example, the input data 428 includes the sequence of image frames 112, the image latent data 122, the image FEs 152, the sets of IFG identifiers 124, the CBIs 170, the IFG latent data 126, the CB FEs 174, the query 136, the user input 172, the sets of image tokens 322, the linguistic tokens 324, the input embeddings 326, or a combination thereof.

The integrated circuit 402 also includes output circuitry 406, such as a bus interface, to enable sending of output data 430. In a particular aspect, the output data 430 includes data generated by one or more of the components 440, as described herein. For example, the output data 430 includes the sequence of image frames 112, the image latent data 122, the image FEs 152, the sets of IFG identifiers 124, the CBIs 170, the IFG latent data 126, the CB FEs 174, the response 138, the sets of image tokens 322, the linguistic tokens 324, the input embeddings 326, or a combination thereof.

The integrated circuit 402 enables implementation of hierarchical vision encoding enabled cognitive analysis as a component in a system, such as a mobile phone or tablet as depicted in FIG. 5, a wearable electronic device as depicted in FIG. 6A, a mixed reality or augmented reality glasses device, as described with reference to FIG. 7A, a voice-controlled speaker system as depicted in FIG. 8A, a camera as depicted in FIG. 9A, a virtual reality, mixed reality, or augmented reality headset as depicted in FIG. 10A, or a vehicle as depicted in FIG. 11A or FIG. 12A.

FIG. 5 depicts an implementation 500 of a mobile device 502, such as a phone or tablet, as illustrative, non-limiting examples. In a particular aspect, the mobile device 502 corresponds to an implementation of the device 102, the device 202, or both.

The mobile device 502 includes a display screen 504, and optionally the image source 106. The one or more components 440 of the processor(s) 490 are integrated in the mobile device 502 and are illustrated using dashed lines to indicate internal components that are not generally visible to a user of the mobile device 502. In a particular example, the image-based cognitive analyzer 146 detects the query 136, which is then processed to perform one or more operations at the mobile device 502, such as to launch a graphical user interface or otherwise display the response 138 at the display screen 504 (e.g., via an integrated “smart assistant” application).

The mobile device 502 performs one or more operations described with reference to the device 102, the device 202, or both, of FIGS. 1A-3. For example, in some aspects, the mobile device 502 obtains the image frames 112 from the image source 106 and generates the sets of IFG identifiers 124, as described with reference to the device 102 of FIG. 1A. The mobile device 502, responsive to receiving the query 136, uses the image-based cognitive analyzer 146 to generate the response 138 and outputs the response 138, as described with reference to the device 102 of FIG. 1A.

In some aspects, the mobile device 502 obtains the image frames 112 from the image source 106, generates the sets of IFG identifiers 124, and sends the sets of IFG identifiers 124 to another device, as described with reference to the device 102 of FIG. 2. The other device uses the image-based cognitive analyzer 146 to generate the response 138, as described with reference to the device 202 of FIG. 2. In some examples, the mobile device 502 receives the query 136 and provides the query 136 to the other device, receives the response 138 from the other device, and outputs the response 138. In some examples, the other device receives the query 136, uses the image-based cognitive analyzer 146 to generate the response 138, and outputs the response 138, as described with reference to the device 202 of FIG. 2.

In some aspects, the mobile device 502 obtains the sets of IFG identifiers 124 from a second device (e.g., XR glasses), uses the image-based cognitive analyzer 146 to perform the cognitive analysis to generate the response 138, and outputs the response 138, as described with reference to the device 202 of FIG. 2.

FIG. 6A depicts an implementation 600 of a wearable electronic device 602, illustrated as a “smart watch.” In a particular aspect, the wearable electronic device 602 corresponds to an implementation of the device 102, the device 202, or both.

The one or more components 440, and optionally the image source 106, are integrated into the wearable electronic device 602. The wearable electronic device 602 performs one or more operations described with reference to the device 102, the device 202, or both, of FIGS. 1A-3. For example, the component(s) 440 operate to obtain the image frames 112, the sets of IFG identifiers 124, the query 136, the response 138, or a combination thereof, which are then processed to perform one or more operations at the wearable electronic device 602, such as to launch a graphical user interface or otherwise display other information associated with the image frames 112, the sets of IFG identifiers 124, the query 136, the response 138, or a combination thereof at a display screen 604 of the wearable electronic device 602.

In some aspects, the wearable electronic device 602 may include a display screen that is configured to display a notification based on obtaining the image frames 112, the sets of IFG identifiers 124, the query 136, the response 138, or a combination thereof. In a particular example, the wearable electronic device 602 includes a haptic device that provides a haptic notification (e.g., vibrates) in response to obtaining the image frames 112, the sets of IFG identifiers 124, the query 136, the response 138, or a combination thereof. For example, the haptic notification can cause a user to look at the wearable electronic device 602 to see a displayed notification indicating detection of the image frames 112, the sets of IFG identifiers 124, the query 136, the response 138, or a combination thereof. The wearable electronic device 602 can thus alert a user with a hearing impairment or a user wearing a headset that the image frames 112, the sets of IFG identifiers 124, the query 136, the response 138, or a combination thereof, are detected.

FIG. 6B depicts an example 650 of the mobile device 502 and the wearable electronic device 602. The wearable electronic device 602 is configured to process an image frame 112 to generate a set of IFG identifiers 124, as described with reference to FIGS. 1A-2. The wearable electronic device 602 is configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

It should be understood that the mobile device 502 is provided as an illustrative example of a recipient device that receives the set of IFG identifiers 124; in other examples various types of devices can be recipients of a set of IFG identifiers 124. In some examples, the mobile device 502 can transmit a set of IFG identifiers 124 to various other devices.

FIG. 7A depicts an implementation 700 of a portable electronic device that corresponds to augmented reality or mixed reality glasses 702. In a particular aspect, the glasses 702 correspond to an implementation of the device 102, the device 202, or both.

The glasses 702 include a holographic projection unit 704 configured to project visual data onto a surface of a lens 706 or to reflect the visual data off of a surface of the lens 706 and onto the wearer's retina. The one or more components 440 and, optionally the image source 106, are integrated into the glasses 702. The glasses 702 perform one or more operations described with reference to the device 102, the device 202, or both, of FIGS. 1A-3. For example, the component(s) 440 may function to obtain the image frames 112, the sets of IFG identifiers 124, the query 136, the response 138, or a combination thereof, as described with reference to FIGS. 1A and 2.

In a particular example, the holographic projection unit 704 is configured to display a notification based on obtaining the image frames 112, the sets of IFG identifiers 124, the query 136, the response 138, or a combination thereof. For example, the notification can be superimposed on the user's field of view at a particular position that coincides with a location related to an answer indicated in the response 138.

FIG. 7B depicts an example 750 of the mobile device 502 and the glasses 702. The glasses 702 are configured to process an image frame 112 to generate a set of IFG identifiers 124, as described with reference to FIGS. 1A-2. The glasses 702 are configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

FIG. 8A is an implementation 800 of a wireless speaker and voice activated device 802. In a particular aspect, the wireless speaker and voice activated device 802 corresponds to an implementation of the device 102, the device 202, or both.

The wireless speaker and voice activated device 802 can have wireless network connectivity and is configured to execute an assistant operation. The one or more components 440 and, optionally the image source 106, are integrated into the wireless speaker and voice activated device 802. The wireless speaker and voice activated device 802 also includes a speaker 804.

The wireless speaker and voice activated device 802 performs one or more operations described with reference to the device 102, the device 202, or both, of FIGS. 1A-3. For example, the component(s) 440 may function to obtain the image frames 112, the sets of IFG identifiers 124, the query 136, the response 138, or a combination thereof, as described with reference to FIGS. 1A and 2.

During operation, in response to receiving a verbal command, the wireless speaker and voice activated device 802 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In an example, the assistant operations include generating the response 138 to the query 136, as described with reference to the device 102, the device 202, or both, of FIGS. 1A and 2.

FIG. 8B depicts an example 850 of the mobile device 502 and the wireless speaker and voice activated device 802. The wireless speaker and voice activated device 802 is configured to process an image frame 112 to generate a set of IFG identifiers 124, as described with reference to FIGS. 1A-2. The wireless speaker and voice activated device 802 is configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

FIG. 9A depicts an implementation 900 of a portable electronic device that corresponds to a camera device 902. In a particular aspect, the camera device 902 corresponds to an implementation of the device 102, the device 202, or both.

The one or more components 440 and, optionally the image source 106, are included in the camera device 902. The camera device 902 performs one or more operations described with reference to the device 102, the device 202, or both, of FIGS. 1A-3. For example, the component(s) 440 may function to obtain the image frames 112, the sets of IFG identifiers 124, the query 136, the response 138, or a combination thereof, as described with reference to FIGS. 1A and 2.

During operation, in response to receiving a verbal command, the camera device 902 can execute operations responsive to spoken user commands, such as to adjust image or video capture settings, image or video playback settings, or image or video capture instructions, as illustrative examples. In an example, the camera device 902 generates the response 138 to the query 136, as described with reference to the device 102, the device 202, or both, of FIGS. 1A and 2.

FIG. 9B depicts an example 950 of the mobile device 502 and the camera device 902. The camera device 902 is configured to process an image frame 112 to generate a set of IFG identifiers 124, as described with reference to FIGS. 1A-2. The camera device 902 is configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

FIG. 10A depicts an implementation 1000 of a portable electronic device that corresponds to a virtual reality, mixed reality, or augmented reality headset 1002. In a particular aspect, the headset 1002 corresponds to an implementation of the device 102, the device 202, or both.

The one or more components 440 and, optionally the image source 106, are included in the headset 1002. The headset 1002 performs one or more operations described with reference to the device 102, the device 202, or both, of FIGS. 1A-3. For example, the component(s) 440 may function to obtain the image frames 112, the sets of IFG identifiers 124, the query 136, the response 138, or a combination thereof, as described with reference to FIGS. 1A and 2.

In some aspects, the headset 1002 obtains the sequence of image frames 112 from the image source 106, generates the sets of IFG identifiers 124, and sends the sets of IFG identifiers 124 to another device (e.g., the mobile device 502 of FIG. 5), as described with reference to the device 102 of FIG. 2. The other device uses the image-based cognitive analyzer 146 to generate the response 138, as described with reference to the device 202 of FIG. 2. The headset 1002, the other device, or both, output the response 138.

In an example, a visual interface device is positioned in front of the user's eyes to enable display of augmented reality, mixed reality, or virtual reality images or scenes to the user while the headset 1002 is worn. In a particular example, the visual interface device is configured to display a notification indicating that image frames 112, the sets of IFG identifiers 124, the query 136, the response 138, or a combination thereof, are detected. In some examples, the visual interface is configured to display the response 138.

FIG. 10B depicts an example 1050 of the mobile device 502 and the headset 1002. The headset 1002 is configured to process an image frame 112 to generate a set of IFG identifiers 124, as described with reference to FIGS. 1A-2. The headset 1002 is configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

FIG. 11A depicts an implementation 1100 of a vehicle 1102, illustrated as a manned or unmanned aerial device (e.g., a package delivery drone). In a particular aspect, the device 102, the device 202, or both, correspond to or are integrated into the vehicle 1102.

The one or more components 440 and, optionally the image source 106, are included in the vehicle 1102. The vehicle 1102 performs one or more operations described with reference to the device 102, the device 202, or both, of FIGS. 1A-3. For example, the component(s) 440 may function to obtain the image frames 112, the sets of IFG identifiers 124, the query 136, the response 138, or a combination thereof, as described with reference to FIGS. 1A and 2.

In an example, the vehicle 1102 receives a query 136, such as for installation instructions, of a delivered package depicted in the sequence of image frames 112. The vehicle 1102 processes the image frames 112 to generate the sets of IFG identifiers 124. In some examples, the vehicle 1102 uses the image-based cognitive analyzer 146 to process the sets of IFG identifiers 124 to generate the response 138 to the query 136, as described with reference to the device 102 of FIG. 1A. In some examples, the vehicle 1102 sends the sets of IFG identifiers 124 to another device, as described with reference to the device 102 of FIG. 2. The other device uses the image-based cognitive analyzer 146 to process the sets of IFG identifiers 124 to generate the response 138, as described with reference to the device 202 of FIG. 2. In a particular aspect, the vehicle 1102 outputs the response 138.

FIG. 11B depicts an example 1150 of the mobile device 502 and the vehicle 1102. The vehicle 1102 is configured to process an image frame 112 to generate a set of IFG identifiers 124, as described with reference to FIGS. 1A-2. The vehicle 1102 is configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

FIG. 12A depicts another implementation 1200 of a vehicle 1202, illustrated as a car. In a particular aspect, the vehicle 1202 corresponds to an implementation of the device 102, the device 202, or both. In a particular aspect, the device 102, the device 202, or both, correspond to or are integrated into the vehicle 1202.

The one or more components 440 and, optionally the image source 106, are included in the vehicle 1202. In some aspects, the vehicle 1202 includes a microphone 1222. The vehicle 1202 performs one or more operations described with reference to the device 102, the device 202, or both, of FIGS. 1A-3. For example, the component(s) 440 may function to obtain the image frames 112, the sets of IFG identifiers 124, the query 136, the response 138, or a combination thereof, as described with reference to FIGS. 1A and 2.

In some aspects, the query 136 may be detected based on audio signals received from the microphone 1222 of the vehicle 1202. In some implementations, query detection can be performed based on an audio signal received from interior microphones (e.g., the microphone 1222), such as for a voice query from an authorized passenger. In some implementations, query detection can be performed based on an audio signal received from external microphones (e.g., the microphone 1222), such as an authorized user of the vehicle. In a particular implementation, in response to receiving a verbal command, a voice activation system initiates one or more operations of the vehicle 1202 based on one or more keywords (e.g., “unlock,” “start engine,” “play music,” “display weather forecast,” or another voice command) detected in an audio signal, such as by providing feedback or information via a display 1220 or one or more speakers (e.g., a speaker 1210).

In some aspects, the vehicle 1202 processes image frames 112 to generate the sets of IFG identifiers 124. In some examples, the vehicle 1202 uses the image-based cognitive analyzer 146 to process the sets of IFG identifiers 124 to generate the response 138 to the query 136, as described with reference to the device 102 of FIG. 1A. In some examples, the vehicle 1202 sends the sets of IFG identifiers 124 to another device, as described with reference to the device 102 of FIG. 2. The other device uses the image-based cognitive analyzer 146 to process the sets of IFG identifiers 124 to generate the response 138, as described with reference to the device 202 of FIG. 2. In a particular aspect, the other device sends the response 138 to the vehicle 1202. In some examples, the vehicle 1202 receives the sets of IFG identifiers 124 from another device and uses the image-based cognitive analyzer 146 to process the sets of IFG identifiers 124 to generate the response 138, as described with reference to the device 202 of FIG. 2. In a particular aspect, the vehicle 1202 outputs the response 138 via the display 1220, the speaker 1210, or both.

FIG. 12B depicts an example 1250 of the mobile device 502 and the vehicle 1202. The vehicle 1202 is configured to process an image frame 112 to generate a set of IFG identifiers 124, as described with reference to FIGS. 1A-2. The vehicle 1202 is configured to transmit the set of IFG identifiers 124 to the mobile device 502. The mobile device 502 is configured to perform image-based cognitive analysis based on the set of IFG identifiers 124 to generate a response 138 to a query 136, as described with reference to FIGS. 1A, 2, and 3. In some examples, an image frame 112 can depict sensitive information, people, homes, offices, etc., and transmitting the set of IFG identifiers 124 instead of the image frame 112 enhances security.

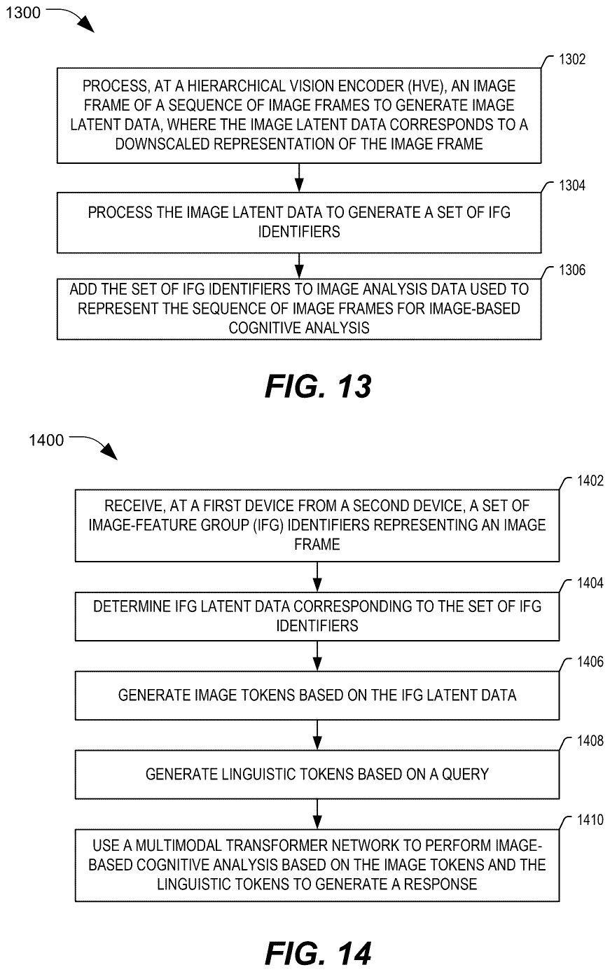

Referring to FIG. 13, a particular implementation of a method 1300 of performing hierarchical vision encoding enabled cognitive analysis is shown. In a particular aspect, one or more operations of the method 1300 are performed by at least one of the stages 140, the HVE 180, the L2I resolver 142, the one or more processors 190, the device 102, the system 100 of FIG. 1A, the multi-context local attention(s) 160, the downscaling layer(s) 162 of FIG. 1B, the system 200 of FIG. 2, the one or more components 440, the integrated circuit 402 of FIG. 4, or a combination thereof.

The method 1300 includes, at 1302, processing, at a hierarchical vision encoder (HVE), an image frame of a sequence of image frames to generate image latent data, where the image latent data corresponds to a downscaled representation of the image frame. For example, the HVE 180 processes the image frame 112A of the sequence of image frames 112 to generate the image latent data 122A, as described with reference to FIG. 1A. The image latent data 122A corresponds to a downscaled representation of the image frame 112A.

The method 1300 includes, at 1304, processing the image latent data to generate a set of IFG identifiers. For example, the L2I resolver 142 processes the image latent data 122A to generate the set of IFG identifiers 124A, as described with reference to FIG. 1A.

The method 1300 includes, at 1306, adding the set of IFG identifiers to image analysis data used to represent the sequence of image frames for image-based cognitive analysis. For example, the L2I resolver 142 adds the set of IFG identifiers 124A to the image analysis data 148 stored at the memory 132 of the device 102, as described with reference to FIG. 1A. The image analysis data 148 is used to represent the sequence of image frames 112 for image-based cognitive analysis. As another example, the L2I resolver 142 adds the set of IFG identifiers 124A to the image analysis data 248 stored at the memory 232 of the device 202, as described with reference to FIG. 2. The image analysis data 248 is used to represent the sequence of image frames 112 for image-based cognitive analysis.

A technical advantage of the method 1300 includes accessibility to data associated with more image frames 112 for cognitive analysis. For example, the set of IFG identifiers 124A is smaller than the image frame 112A. With limited storage capacity, sets of IFG identifiers 124 corresponding to more image frames 112 can be stored in the memory 132 and the memory 232 than original image frames 112.

Another technical advantage of the method 1300 can include enhanced security. For example, because the set of IFG identifiers 124A represents the IFG latent data 126A that is an approximation of the image latent data 122 and also because the image latent data 122 corresponds to a downsampled representation of the image frame 112A, the set of IFG identifiers 124A that is stored in the memory 132 or transmitted to the device 202 and stored in the memory 232 cannot typically be used to generate an accurate reproduction of the image frame 112A.

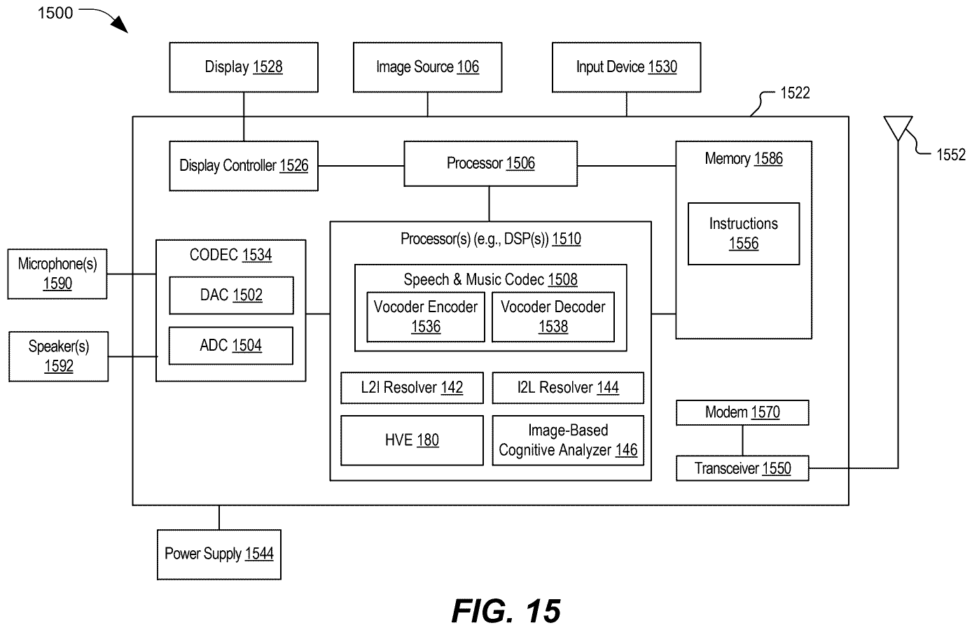

The method 1300 of FIG. 13 may be implemented by a FPGA device, an application-specific integrated circuit (ASIC), a processing unit such as a central processing unit (CPU), a digital signal processor (DSP), a controller, another hardware device, firmware device, or any combination thereof. As an example, the method 1300 of FIG. 13 may be performed by a processor that executes instructions, such as described with reference to FIG. 15.

Referring to FIG. 14, a particular implementation of a method 1400 of performing hierarchical vision encoding enabled cognitive analysis is shown. In a particular aspect, one or more operations of the method 1400 are performed by at least one of the image-based cognitive analyzer 146 of FIG. 1A, the memory 232, the I2L resolver 144, the one or more processors 290, the device 202, the system 200 of FIG. 2, the projector 340, the tokenizer 342, the embedding generator 344, the multimodal transformer network 346 of FIG. 3, the one or more components 440, the integrated circuit 402 of FIG. 4, or a combination thereof.

The method 1400 includes, at 1402, receiving, at a first device from a second device, a set of image-feature group (IFG) identifiers representing an image frame. For example, the device 202 of FIG. 2 receives, from the device 102, the set of IFG identifiers 124A representing the image frame 112A, as described with reference to FIG. 2.

The method 1400 includes, at 1404, determining IFG latent data corresponding to the set of IFG identifiers. For example, the I2L resolver 144 determines the IFG latent data 126A corresponding to the set of IFG identifiers 124A, as described with reference to FIGS. 1A and 2.

The method 1400 includes, at 1406, generating image tokens based on the IFG latent data. For example, the projector 340 generates the set of image tokens 322A, the set of image tokens 322B, one or more additional sets of image tokens 322, or a combination thereof, based on the IFG latent data 126A, as described with reference to FIG. 3.

The method 1400 includes, at 1408, generating linguistic tokens based on a query. For example, the tokenizer 342 generates the linguistic tokens 324 based on the query 136, as described with reference to FIG. 3.

The method 1400 includes, at 1410, using a multimodal transformer network to perform image-based cognitive analysis based on the image tokens and the linguistic tokens to generate a response. For example, the image-based cognitive analyzer 146 uses the multimodal transformer network 346 to perform image-based cognitive analysis based on the sets of image tokens 322 and the linguistic tokens 324, as described with reference to FIG. 3.

A technical advantage of the method 1400 includes offloading storage of the sets of IFG identifiers 124 and performance of the image-based cognitive analysis from the device 102 (e.g., XR glasses) to the device 202 (e.g., a companion device). Hence, the device 102 can be a relatively light-weight device, with the device 202 having more resources (e.g., more memory, computing resources, or both). Because the image frame 112A can typically not be accurately reproduced from the set of IFG identifiers 124A, transmitting the set of IFG identifiers 124A to the device 202 maintains security.

The method 1400 of FIG. 14 may be implemented by a FPGA device, an ASIC, a processing unit such as a CPU, a DSP, a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102, the device 202, or both. In an illustrative implementation, the device 1500 may perform one or more operations described with reference to FIGS. 1A-14.

In a particular implementation, the device 1500 includes a processor 1506 (e.g., a CPU). The device 1500 may include one or more additional processors 1510 (e.g., one or more DSPs). In a particular aspect, the one or more processors 190 of FIG. 1A, the one or more processors 290 of FIG. 2, the one or more processors 490 of FIG. 4, or a combination thereof, correspond to the processor 1506, the processors 1510, or a combination thereof. The processors 1510 may include a speech and music coder-decoder (CODEC) 1508 that includes a voice coder (“vocoder”) encoder 1536, a vocoder decoder 1538, or both. The processors 1510 include the HVE 180, the L2I resolver 142, the I2L resolver 144, the image-based cognitive analyzer 146, or a combination thereof. Optionally, in some embodiments, the processors 1510 include the image source 106.

The device 1500 may include a memory 1586 and a CODEC 1534. The memory 1586 may include instructions 1556, that are executable by the one or more additional processors 1510 (or the processor 1506) to implement the functionality described with reference to the one or more components 440. The one or more components 440 include the HVE 180, the L2I resolver 142, the I2L resolver 144, the image-based cognitive analyzer 146, the image source 106, or a combination thereof, as described with reference to FIG. 4. The device 1500 may include a modem 1570 coupled, via a transceiver 1550, to an antenna 1552.

In a particular aspect, the modem 1570 is configured to transmit one or more sets of IFG identifiers 124, receive one or more sets of IFG identifiers 124, or both. For example, the modem 1570 may transmit one or more first sets of IFG identifiers 124 to one device and receive one or more second sets of IFG identifiers 124 from another device. Optionally, in some embodiments, the modem 1570 is configured to receive the sequence of image frames 112 from the image source 106. Optionally, in some embodiments, the modem 1570 is configured to receive, transmit, or both, the query 136, the response 138, or both.

The device 1500 may include a display 1528 coupled to a display controller 1526. One or more speakers 1592, one or more microphones 1590, or a combination thereof may be coupled to the CODEC 1534. The CODEC 1534 may include a digital-to-analog converter (DAC) 1502, an analog-to-digital converter (ADC) 1504, or both. In a particular implementation, the CODEC 1534 may receive analog signals from the one or more microphones 1590, convert the analog signals to digital signals using the analog-to-digital converter 1504, and provide the digital signals to the speech and music codec 1508. The speech and music codec 1508 may process the digital signals. In a particular implementation, the speech and music codec 1508 may provide digital signals to the CODEC 1534. The CODEC 1534 may convert the digital signals to analog signals using the digital-to-analog converter 1502 and may provide the analog signals to the one or more speakers 1592.

In a particular implementation, the device 1500 may be included in a system-in-package or system-on-chip device 1522. In a particular implementation, the memory 1586, the processor 1506, the processors 1510, the display controller 1526, the CODEC 1534, and the modem 1570 are included in the system-in-package or system-on-chip device 1522. In a particular implementation, an input device 1530, a power supply 1544, and optionally the image source 106, are coupled to the system-in-package or the system-on-chip device 1522. Moreover, in a particular implementation, as illustrated in FIG. 15, the display 1528, the input device 1530, the one or more speakers 1592, the one or more microphones 1590, the antenna 1552, the power supply 1544, and optionally the image source 106, are external to the system-in-package or the system-on-chip device 1522. In a particular implementation, each of the display 1528, the input device 1530, the one or more speakers 1592, the one or more microphones 1590, the antenna 1552, the power supply 1544, and optionally the image source 106 may be coupled to a component of the system-in-package or the system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an extended reality headset, an aerial vehicle, a home automation system, a voice-activated device, a wireless speaker and voice activated device, a portable electronic device, a car, a computing device, a communication device, an internet-of-things (IoT) device, a virtual reality (VR) device, an extended reality (XR) device, a base station, a mobile device, or any combination thereof.

In conjunction with the described implementations, an apparatus includes means for processing, at a hierarchical vision encoder (HVE), an image frame of a sequence of image frames to generate image latent data, where the image latent data corresponds to a downscaled representation of the image frame. For example, the means for processing at the HVE can correspond to the stages 140, the HVE 180, the one or more processors 190, the device 102, the system 100 of FIG. 1A, the multi-context local attention(s) 160, the downscaling layer(s) 162 of FIG. 1B, the system 200 of FIG. 2, the one or more components 440, the one or more processors 490, the integrated circuit 402 of FIG. 4, the processor 1506, the processor 1510, the device 1500 of FIG. 15, one or more other circuits or components configured to process an image frame 112 at the HVE 180, or any combination thereof.

The apparatus also includes means for processing the image latent data to generate a set of IFG identifiers. For example, the means for processing can correspond to the L2I resolver 142, the one or more processors 190, the device 102, the system 100 of FIG. 1A, the system 200 of FIG. 2, the one or more components 440, the one or more processors 490, the integrated circuit 402 of FIG. 4, the processor 1506, the processor 1510, the device 1500 of FIG. 15, one or more other circuits or components configured to process image latent data 122 at the L2I resolver 142, or any combination thereof.

The apparatus further includes means for adding the set of IFG identifiers to image analysis data used to represent the sequence of image frames for image-based cognitive analysis. For example, the means for adding can correspond to the L2I resolver 142, the memory 132, the one or more processors 190, the device 102, the system 100 of FIG. 1A, the memory 232, the device 202, the system 200 of FIG. 2, the one or more components 440, the one or more processors 490, the integrated circuit 402 of FIG. 4, the processor 1506, the processor 1510, the device 1500 of FIG. 15, one or more other circuits or components configured to add a set of sets of IFG identifiers 124 to image analysis data 148, or any combination thereof.

Also, in conjunction with the described implementations, an apparatus includes means for receiving, from a device, a set of image-feature group (IFG) identifiers representing an image frame. For example, the means for receiving can correspond to the one or more processors 290, the memory 232, the device 202, the system 200 of FIG. 2, the one or more components 440, the one or more processors 490, the integrated circuit 402 of FIG. 4, the processor 1506, the processor 1510, the antenna 1552, the transceiver 1550, the modem 1570, the device 1500 of FIG. 15, one or more other circuits or components configured to receive a set of IFG identifiers 124, or any combination thereof.

The apparatus also includes means for determining IFG latent data corresponding to the set of IFG identifiers. For example, the means for determining can correspond to the I2L resolver 144, the one or more processors 190, the device 102, the system 100 of FIG. 1A, the one or more processors 290, the device 202, the system 200 of FIG. 2, the one or more components 440, the one or more processors 490, the integrated circuit 402 of FIG. 4, the processor 1506, the processor 1510, the device 1500 of FIG. 15, one or more other circuits or components configured to determine the image latent data 122, or any combination thereof.

The apparatus further includes means for generating image tokens based on the IFG latent data. For example, the means for generating can correspond to the image-based cognitive analyzer 146, the one or more processors 190, the device 102, the system 100 of FIG. 1A, the one or more processors 290, the device 202, the system 200 of FIG. 2, the projector 340 of FIG. 3, the one or more components 440, the one or more processors 490, the integrated circuit 402 of FIG. 4, the processor 1506, the processor 1510, the device 1500 of FIG. 15, one or more other circuits or components configured to generate a set of image tokens 322, or any combination thereof.

The apparatus also includes means for generating linguistic tokens based on a query. For example, the means for generating can correspond to the image-based cognitive analyzer 146, the one or more processors 190, the device 102, the system 100 of FIG. 1A, the one or more processors 290, the device 202, the system 200 of FIG. 2, the tokenizer 342 of FIG. 3, the one or more components 440, the one or more processors 490, the integrated circuit 402 of FIG. 4, the processor 1506, the processor 1510, the device 1500 of FIG. 15, one or more other circuits or components configured to generate the linguistic tokens 324, or any combination thereof.

The apparatus further includes means for using a multimodal transformer network to perform image-based cognitive analysis based on the image tokens and the linguistic tokens to generate a response. For example, the means for using can correspond to the image-based cognitive analyzer 146, the one or more processors 190, the device 102, the system 100 of FIG. 1A, the one or more processors 290, the device 202, the system 200 of FIG. 2, the multimodal transformer network 346 of FIG. 3, the one or more components 440, the one or more processors 490, the integrated circuit 402 of FIG. 4, the processor 1506, the processor 1510, the device 1500 of FIG. 15, one or more other circuits or components configured to use the multimodal transformer network 346, or any combination thereof.

In some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to process, at a hierarchical vision encoder (HVE) (e.g., the HVE 180), an image frame (e.g., the image frame 112A) of a sequence of image frames (e.g., the image frames 112) to generate image latent data (e.g., the image latent data 122A). The image latent data corresponds to a downscaled representation of the image frame. The instructions further cause the one or more processors to process the image latent data to generate a set of IFG identifiers (e.g., the set of IFG identifiers 124A). The instructions further cause the one or more processors to add the set of IFG identifiers to image analysis data (e.g., the image analysis data 148, the image analysis data 248, or both) used to represent the sequence of image frames for image-based cognitive analysis.

Also, in some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to receive, from a device (e.g., the device 102), a set of image-feature group (IFG) identifiers (e.g., the set of IFG identifiers 124A) representing an image frame (e.g., the image frame 112A). The instructions further cause the one or more processors to determine IFG latent data (e.g., the image latent data 122A) corresponding to the set of IFG identifiers. The instructions further cause the one or more processors to generate image tokens (e.g., the sets of image tokens 322) based on the IFG latent data. The instructions further cause the one or more processors to generate linguistic tokens (e.g., the linguistic tokens 324) based on a query (e.g., the query 136). The instructions further cause the one or more processors to use a multimodal transformer network (e.g., the multimodal transformer network 346) to perform image-based cognitive analysis based on the image tokens and the linguistic tokens to generate a response (e.g., the response 138).

Particular aspects of the disclosure are described below in sets of interrelated Examples:

According to Example 1, a device includes a memory configured to store one or more image-feature group (IFG) identifiers; and one or more processors coupled to the memory and configured to process, at a hierarchical vision encoder (HVE), an image frame of a sequence of image frames to generate image latent data, wherein the image latent data corresponds to a downscaled representation of the image frame; process the image latent data to generate a set of IFG identifiers; and add the set of IFG identifiers to image analysis data used to represent the sequence of image frames for image-based cognitive analysis.

Example 2 includes the device of Example 1, wherein the image-based cognitive analysis includes processing linguistic inputs and image-based inputs using a multimodal transformer network.

Example 3 includes the device of Example 1 or Example 2, wherein the image-based cognitive analysis includes processing linguistic inputs and image-based inputs using a large language model (LLM).

Example 4 includes the device of any of Examples 1 to 3, wherein the one or more processors are configured to perform the image-based cognitive analysis.

Example 5 includes the device of any of Examples 1 to 4, wherein the one or more processors are configured to determine IFG latent data corresponding to the set of IFG identifiers; generate image tokens based on the IFG latent data; generate linguistic tokens based on a query; and use a large language model (LLM) to perform the image-based cognitive analysis based on the image tokens and the linguistic tokens to generate a response.

Example 6 includes the device of any of Examples 1 to 5, wherein the one or more processors are configured to initiate transmission of the set of IFG identifiers to a second device that performs the image-based cognitive analysis.

Example 7 includes the device of any of Examples 1 to 6, wherein the one or more processors are configured to initiate transmission of the set of IFG identifiers to a second device for the image-based cognitive analysis, wherein a multimodal transformer network is used to perform the image-based cognitive analysis based on image tokens and linguistic tokens to generate a response, and wherein the image tokens are based on the set of IFG identifiers.

Example 8 includes the device of any of Examples 1 to 7, wherein the image latent data includes a plurality of image feature embeddings corresponding to the downscaled representation of the image frame, wherein the one or more processors are configured to use a codebook to determine a set of codebook indices of a plurality of codebook feature embeddings that match the plurality of image feature embeddings, and wherein the set of IFG identifiers includes the set of codebook indices.

Example 9 includes the device of any of Examples 1 to 8, wherein the image latent data includes a plurality of image feature embeddings corresponding to the downscaled representation of the image frame, wherein the one or more processors are configured to determine a set of cluster identifiers of a plurality of feature embedding clusters that match the plurality of image feature embeddings, and wherein the set of IFG identifiers includes the set of cluster identifiers.

Example 10 includes the device of any of Examples 1 to 9, wherein the one or more processors and the memory are integrated in a headset, a communication device, or both.

Example 11 includes the device of any of Examples 1 to 10, and further includes a modem coupled to the one or more processors and configured to initiate transmission of the set of IFG identifiers.

Example 12 includes the device of any of Examples 1 to 11, and further includes a modem coupled to the one or more processors and configured to receive the sequence of image frames.

Example 13 includes the device of any of Examples 1 to 12, and further includes a camera coupled to the one or more processors and configured to generate the sequence of image frames.

Example 14 includes the device of any of Examples 1 to 13, wherein the set of IFG identifiers is not useable to generate an accurate reproduction of the image frame.

According to Example 15, a device includes a memory configured to store one or more image-feature group (IFG) identifiers; and one or more processors configured to receive, from a second device, a set of IFG identifiers representing an image frame; determine IFG latent data corresponding to the set of IFG identifiers; generate image tokens based on the IFG latent data; generate linguistic tokens based on a query; and use a multimodal transformer network to perform image-based cognitive analysis based on the image tokens and the linguistic tokens to generate a response.

Example 16 includes the device of Example 15, wherein the multimodal transformer network includes a large language model (LLM).

Example 17 includes the device of Example 15 or Example 16, wherein the one or more processors are configured to use a codebook to determine a plurality of codebook feature embeddings corresponding to a set of codebook indices, wherein the set of IFG identifiers includes the set of codebook indices; and process the plurality of codebook feature embeddings to generate the image tokens.

Example 18 includes the device of any of Examples 15 to 17, wherein the one or more processors are configured to determine a plurality of cluster feature embeddings corresponding to a set of cluster identifiers, wherein the set of IFG identifiers includes the set of cluster identifiers; and process the plurality of cluster feature embeddings to generate the image tokens.

Example 19 includes the device of any of Examples 15 to 18, wherein the one or more processors and the memory are integrated in a communication device.

Example 20 includes the device of any of Examples 15 to 19, and further includes a modem coupled to the one or more processors and configured to receive the set of IFG identifiers.

Example 21 includes the device of any of Examples 15 to 20, and further includes a modem coupled to the one or more processors and configured to transmit the response.

According to Example 22, a method includes processing, at a hierarchical vision encoder (HVE), an image frame of a sequence of image frames to generate image latent data, wherein the image latent data corresponds to a downscaled representation of the image frame; processing the image latent data to generate a set of IFG identifiers; and adding the set of IFG identifiers to image analysis data used to represent the sequence of image frames for image-based cognitive analysis.

Example 23 includes the method of Example 22, wherein the image-based cognitive analysis includes processing linguistic inputs and image-based inputs using a multimodal transformer network.

Example 24 includes the method of Example 22 or Example 23, wherein the image-based cognitive analysis includes processing linguistic inputs and image-based inputs using a large language model (LLM).

Example 25 includes the method of any of Examples 22 to 24, and further includes performing the image-based cognitive analysis.

Example 26 includes the method of any of Examples 22 to 25, further includes determining IFG latent data corresponding to the set of IFG identifiers; generating image tokens based on the IFG latent data; generating linguistic tokens based on a query; and using a large language model (LLM) to perform the image-based cognitive analysis based on the image tokens and the linguistic tokens to generate a response.

Example 27 includes the method of any of Examples 22 to 26, and further includes initiating transmission of the set of IFG identifiers to a device that performs the image-based cognitive analysis.

Example 28 includes the method of any of Examples 22 to 27, and further includes initiating transmission of the set of IFG identifiers to a device for the image-based cognitive analysis, wherein a multimodal transformer network is used to perform the image-based cognitive analysis based on image tokens and linguistic tokens to generate a response, and wherein the image tokens are based on the set of IFG identifiers.

Example 29 includes the method of any of Examples 22 to 28, wherein the image latent data includes a plurality of image feature embeddings corresponding to the downscaled representation of the image frame, further comprising using a codebook to determine a set of codebook indices of a plurality of codebook feature embeddings that match the plurality of image feature embeddings, and wherein the set of IFG identifiers includes the set of codebook indices.

Example 30 includes the method of any of Examples 22 to 29, wherein the image latent data includes a plurality of image feature embeddings corresponding to the downscaled representation of the image frame, further comprising determining a set of cluster identifiers of a plurality of feature embedding clusters that match the plurality of image feature embeddings, and wherein the set of IFG identifiers includes the set of cluster identifiers.

Example 31 includes the method of any of Examples 22 to 30, wherein the HVE is integrated in a headset, a communication device, or both.

Example 32 includes the method of any of Examples 22 to 31, and further includes initiating transmission of the set of IFG identifiers via a modem.

Example 33 includes the method of any of Examples 22 to 32, and further includes receiving the sequence of image frames via a modem.

Example 34 includes the method of any of Examples 22 to 33, and further includes receiving the sequence of image frames from a camera.

Example 35 includes the method of any of Examples 22 to 34,, wherein the set of IFG identifiers is not useable to generate an accurate reproduction of the image frame.

According to Example 36, a method includes receiving, at a first device from a second device, a set of IFG identifiers representing an image frame; determining, at the first device, IFG latent data corresponding to the set of IFG identifiers; generating, at the first device, image tokens based on the IFG latent data; generating, at the first device, linguistic tokens based on a query; and using, at the first device, a multimodal transformer network to perform image-based cognitive analysis based on the image tokens and the linguistic tokens to generate a response.

Example 37 includes the method of Example 36, wherein the multimodal transformer network includes a large language model (LLM).

Example 38 includes the method of Example 36 or Example 37, further includes using a codebook to determine a plurality of codebook feature embeddings corresponding to a set of codebook indices, wherein the set of IFG identifiers includes the set of codebook indices; and processing the plurality of codebook feature embeddings to generate the image tokens.

Example 39 includes the method of any of Examples 36 to 38, further includes determining a plurality of cluster feature embeddings corresponding to a set of cluster identifiers, wherein the set of IFG identifiers includes the set of cluster identifiers; and processing the plurality of cluster feature embeddings to generate the image tokens.

Example 40 includes the method of any of Examples 36 to 39, wherein the first device includes a communication device.

Example 41 includes the method of any of Examples 36 to 40, and further includes receiving the set of IFG identifiers via a modem.

Example 42 includes the method of any of Examples 36 to 41, and further includes transmitting the response via a modem.

According to Example 43, a non-transitory computer-readable medium stores instructions that, when executed by one or more processors, cause the one or more processors to process, at a hierarchical vision encoder (HVE), an image frame of a sequence of image frames to generate image latent data, wherein the image latent data corresponds to a downscaled representation of the image frame; process the image latent data to generate a set of IFG identifiers; and add the set of IFG identifiers to image analysis data used to represent the sequence of image frames for image-based cognitive analysis.

Example 44 includes the non-transitory computer-readable medium of Example 43, wherein the image-based cognitive analysis includes processing linguistic inputs and image-based inputs using a multimodal transformer network.

Example 45 includes the non-transitory computer-readable medium of Example 43 or Example 44, wherein the image-based cognitive analysis includes processing linguistic inputs and image-based inputs using a large language model (LLM).

Example 46 includes the non-transitory computer-readable medium of any of Examples 43 to 45, wherein the instructions, when executed by one or more processors, cause the one or more processors to perform the image-based cognitive analysis.

Example 47 includes the non-transitory computer-readable medium of any of Examples 43 to 46, wherein the instructions, when executed by one or more processors, cause the one or more processors to determine IFG latent data corresponding to the set of IFG identifiers; generate image tokens based on the IFG latent data; generate linguistic tokens based on a query; and use a large language model (LLM) to perform the image-based cognitive analysis based on the image tokens and the linguistic tokens to generate a response.

Example 48 includes the non-transitory computer-readable medium of any of Examples 43 to 47, wherein the instructions, when executed by one or more processors, cause the one or more processors to initiate transmission of the set of IFG identifiers to a device that performs the image-based cognitive analysis.

Example 49 includes the non-transitory computer-readable medium of any of Examples 43 to 48, wherein the instructions, when executed by one or more processors, cause the one or more processors to initiate transmission of the set of IFG identifiers to a device for the image-based cognitive analysis, wherein a multimodal transformer network is used to perform the image-based cognitive analysis based on image tokens and linguistic tokens to generate a response, and wherein the image tokens are based on the set of IFG identifiers.

Example 50 includes the non-transitory computer-readable medium of any of Examples 43 to 49, wherein the image latent data includes a plurality of image feature embeddings corresponding to the downscaled representation of the image frame, further comprising using a codebook to determine a set of codebook indices of a plurality of codebook feature embeddings that match the plurality of image feature embeddings, and wherein the set of IFG identifiers includes the set of codebook indices.

Example 51 includes the non-transitory computer-readable medium of any of Examples 43 to 50, wherein the image latent data includes a plurality of image feature embeddings corresponding to the downscaled representation of the image frame, further comprising determining a set of cluster identifiers of a plurality of feature embedding clusters that match the plurality of image feature embeddings, and wherein the set of IFG identifiers includes the set of cluster identifiers.

Example 52 includes the non-transitory computer-readable medium of any of Examples 43 to 51, wherein the HVE is integrated in a headset, a communication device, or both.

Example 53 includes the non-transitory computer-readable medium of any of Examples 43 to 52, wherein the instructions, when executed by one or more processors, cause the one or more processors to initiate transmission of the set of IFG identifiers via a modem.

Example 54 includes the non-transitory computer-readable medium of any of Examples 43 to 53, wherein the instructions, when executed by one or more processors, cause the one or more processors to receive the sequence of image frames via a modem.

Example 55 includes the non-transitory computer-readable medium of any of Examples 43 to 54, wherein the instructions, when executed by one or more processors, cause the one or more processors to receive the sequence of image frames from a camera.

Example 56 includes the non-transitory computer-readable medium of any of Examples 43 to 55, wherein the set of IFG identifiers is not useable to generate an accurate reproduction of the image frame.

According to Example 57, a non-transitory computer-readable medium stores instructions that, when executed by one or more processors, cause the one or more processors to receive, from a device, a set of IFG identifiers representing an image frame; determine IFG latent data corresponding to the set of IFG identifiers; generate image tokens based on the IFG latent data; generate linguistic tokens based on a query; and use a multimodal transformer network to perform image-based cognitive analysis based on the image tokens and the linguistic tokens to generate a response.

Example 58 includes the non-transitory computer-readable medium of Example 57, wherein the multimodal transformer network includes a large language model (LLM).

Example 59 includes the non-transitory computer-readable medium of Example 57 or Example 58, wherein the instructions, when executed by one or more processors, cause the one or more processors to use a codebook to determine a plurality of codebook feature embeddings corresponding to a set of codebook indices, wherein the set of IFG identifiers includes the set of codebook indices; and process the plurality of codebook feature embeddings to generate the image tokens.

Example 60 includes the non-transitory computer-readable medium of any of Examples 57 to 59, wherein the instructions, when executed by one or more processors, cause the one or more processors to determine a plurality of cluster feature embeddings corresponding to a set of cluster identifiers, wherein the set of IFG identifiers includes the set of cluster identifiers; and process the plurality of cluster feature embeddings to generate the image tokens.

Example 61 includes the non-transitory computer-readable medium of any of Examples 57 to 60, wherein the device includes a communication device.

Example 62 includes the non-transitory computer-readable medium of any of Examples 57 to 61, wherein the instructions, when executed by one or more processors, cause the one or more processors to receive the set of IFG identifiers via a modem.

Example 63 includes the non-transitory computer-readable medium of any of Examples 57 to 62, wherein the instructions, when executed by one or more processors, cause the one or more processors to transmit the response via a modem.

According to Example 64, an apparatus includes means for processing, at a hierarchical vision encoder (HVE), an image frame of a sequence of image frames to generate image latent data, wherein the image latent data corresponds to a downscaled representation of the image frame; means for processing the image latent data to generate a set of IFG identifiers; and means for adding the set of IFG identifiers to image analysis data used to represent the sequence of image frames for image-based cognitive analysis.

Example 65 includes the apparatus of Example 64, wherein the image-based cognitive analysis includes processing linguistic inputs and image-based inputs using a multimodal transformer network.

Example 66 includes the apparatus of Example 64 or Example 65, wherein the image-based cognitive analysis includes processing linguistic inputs and image-based inputs using a large language model (LLM).

Example 67 includes the apparatus of any of Examples 64 to 66, and further includes means for performing the image-based cognitive analysis.

Example 68 includes the apparatus of any of Examples 64 to 67, further includes means for determining IFG latent data corresponding to the set of IFG identifiers; means for generating image tokens based on the IFG latent data; means for generating linguistic tokens based on a query; and means for using a large language model (LLM) to perform the image-based cognitive analysis based on the image tokens and the linguistic tokens to generate a response.

Example 69 includes the apparatus of any of Examples 64 to 68, and further includes means for initiating transmission of the set of IFG identifiers to a device that performs the image-based cognitive analysis.

Example 70 includes the apparatus of any of Examples 64 to 69, and further includes means for initiating transmission of the set of IFG identifiers to a device for the image-based cognitive analysis, wherein a multimodal transformer network is used to perform the image-based cognitive analysis based on image tokens and linguistic tokens to generate a response, and wherein the image tokens are based on the set of IFG identifiers.

Example 71 includes the apparatus of any of Examples 64 to 70, and further includes means for using a codebook to determine a set of codebook indices of a plurality of codebook feature embeddings that match a plurality of image feature embeddings, wherein the image latent data includes the plurality of image feature embeddings corresponding to the downscaled representation of the image frame, and wherein the set of IFG identifiers includes the set of codebook indices.

Example 72 includes the apparatus of any of Examples 64 to 71, and further includes means for determining a set of cluster identifiers of a plurality of feature embedding clusters that match a plurality of image feature embeddings, wherein the image latent data includes the plurality of image feature embeddings corresponding to the downscaled representation of the image frame, and wherein the set of IFG identifiers includes the set of cluster identifiers.

Example 73 includes the apparatus of any of Examples 64 to 72, wherein at least one of the means for processing an image frame at the HVE, the means for processing the image latent data, or the means for adding the set of IFG identifiers to image analysis data are integrated in a headset, a communication device, or both.

Example 74 includes the apparatus of any of Examples 64 to 73, and further includes means for initiating transmission of the set of IFG identifiers.

Example 75 includes the apparatus of any of Examples 64 to 74, and further includes means for receiving the sequence of image frames.

Example 76 includes the apparatus of any of Examples 64 to 75, and further includes means for generating the sequence of image frames.

Example 77 includes the apparatus of any of Examples 64 to 76, wherein the set of IFG identifiers is not useable to generate an accurate reproduction of the image frame.

According to Example 78, an apparatus includes means for receiving, from a device, a set of IFG identifiers representing an image frame; means for determining IFG latent data corresponding to the set of IFG identifiers; means for generating image tokens based on the IFG latent data; means for generating linguistic tokens based on a query; and means for using a multimodal transformer network to perform image-based cognitive analysis based on the image tokens and the linguistic tokens to generate a response.

Example 79 includes the apparatus of Example 78, wherein the multimodal transformer network includes a large language model (LLM).

Example 80 includes the apparatus of Example 78 or Example 79, further includes means for using a codebook to determine a plurality of codebook feature embeddings corresponding to a set of codebook indices, wherein the set of IFG identifiers includes the set of codebook indices; and means for processing the plurality of codebook feature embeddings to generate the image tokens.

Example 81 includes the apparatus of any of Examples 78 to 80, further includes means for determining a plurality of cluster feature embeddings corresponding to a set of cluster identifiers, wherein the set of IFG identifiers includes the set of cluster identifiers; and means for processing the plurality of cluster feature embeddings to generate the image tokens.

Example 82 includes the apparatus of any of Examples 78 to 81, wherein at least one of the means for receiving a set of IFG identifiers, the means for determining IFG latent data, the means for generating image tokens, the means for generating linguistic tokens, or the means for using a multimodal transformer network are integrated in a communication device.

Example 83 includes the apparatus of any of Examples 78 to 82, and further includes means for receiving the set of IFG identifiers.

Example 84 includes the apparatus of any of Examples 78 to 83, and further includes means for transmitting the response.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store one or more image-feature group (IFG) identifiers; and
one or more processors coupled to the memory and configured to:
process, at a hierarchical vision encoder (HVE), an image frame of a sequence of image frames to generate image latent data, wherein the image latent data corresponds to a downscaled representation of the image frame;
process the image latent data to generate a set of IFG identifiers; and
add the set of IFG identifiers to image analysis data used to represent the sequence of image frames for image-based cognitive analysis.

2. The device of claim 1, wherein the image-based cognitive analysis includes processing linguistic inputs and image-based inputs using a multimodal transformer network.

3. The device of claim 1, wherein the image-based cognitive analysis includes processing linguistic inputs and image-based inputs using a large language model (LLM).

4. The device of claim 1, wherein the one or more processors are configured to perform the image-based cognitive analysis.

5. The device of claim 1, wherein the one or more processors are configured to:
determine IFG latent data corresponding to the set of IFG identifiers;
generate image tokens based on the IFG latent data;
generate linguistic tokens based on a query; and
use a large language model (LLM) to perform the image-based cognitive analysis based on the image tokens and the linguistic tokens to generate a response.

6. The device of claim 1, wherein the one or more processors are configured to initiate transmission of the set of IFG identifiers to a second device that performs the image-based cognitive analysis.

7. The device of claim 1, wherein the one or more processors are configured to initiate transmission of the set of IFG identifiers to a second device for the image-based cognitive analysis, wherein a multimodal transformer network is used to perform the image-based cognitive analysis based on image tokens and linguistic tokens to generate a response, and wherein the image tokens are based on the set of IFG identifiers.

8. The device of claim 1, wherein the image latent data includes a plurality of image feature embeddings corresponding to the downscaled representation of the image frame, wherein the one or more processors are configured to use a codebook to determine a set of codebook indices of a plurality of codebook feature embeddings that match the plurality of image feature embeddings, and wherein the set of IFG identifiers includes the set of codebook indices.

9. The device of claim 1, wherein the image latent data includes a plurality of image feature embeddings corresponding to the downscaled representation of the image frame, wherein the one or more processors are configured to determine a set of cluster identifiers of a plurality of feature embedding clusters that match the plurality of image feature embeddings, and wherein the set of IFG identifiers includes the set of cluster identifiers.

10. The device of claim 1, wherein the one or more processors and the memory are integrated in a headset, a communication device, or both.

11. The device of claim 1, further comprising a modem coupled to the one or more processors and configured to initiate transmission of the set of IFG identifiers.

12. The device of claim 1, further comprising a modem coupled to the one or more processors and configured to receive the sequence of image frames.

13. The device of claim 1, further comprising a camera coupled to the one or more processors and configured to generate the sequence of image frames.

14. The device of claim 1, wherein the set of IFG identifiers is not useable to generate an accurate reproduction of the image frame.

15. A device comprising:
a memory configured to store one or more image-feature group (IFG) identifiers; and
one or more processors configured to:
receive, from a second device, a set of IFG identifiers representing an image frame;
determine IFG latent data corresponding to the set of IFG identifiers;
generate image tokens based on the IFG latent data;
generate linguistic tokens based on a query; and
use a multimodal transformer network to perform image-based cognitive analysis based on the image tokens and the linguistic tokens to generate a response.

16. The device of claim 15, wherein the multimodal transformer network includes a large language model (LLM).

17. The device of claim 15, wherein the one or more processors are configured to:
use a codebook to determine a plurality of codebook feature embeddings corresponding to a set of codebook indices, wherein the set of IFG identifiers includes the set of codebook indices; and
process the plurality of codebook feature embeddings to generate the image tokens.

18. The device of claim 15, wherein the one or more processors are configured to:
determine a plurality of cluster feature embeddings corresponding to a set of cluster identifiers, wherein the set of IFG identifiers includes the set of cluster identifiers; and
process the plurality of cluster feature embeddings to generate the image tokens.

19. The device of claim 15, wherein the one or more processors and the memory are integrated in a communication device.

20. The device of claim 15, further comprising a modem coupled to the one or more processors and configured to receive the set of IFG identifiers.

21. The device of claim 15, further comprising a modem coupled to the one or more processors and configured to transmit the response.

22. A method comprising:
processing, at a hierarchical vision encoder (HVE), an image frame of a sequence of image frames to generate image latent data, wherein the image latent data corresponds to a downscaled representation of the image frame;
processing the image latent data to generate a set of IFG identifiers; and
adding the set of IFG identifiers to image analysis data used to represent the sequence of image frames for image-based cognitive analysis.

23. The method of claim 22, wherein the image-based cognitive analysis includes processing linguistic inputs and image-based inputs using a multimodal transformer network.

24. The method of claim 22, wherein the image-based cognitive analysis includes processing linguistic inputs and image-based inputs using a large language model (LLM).

25. The method of claim 22, further comprising performing the image-based cognitive analysis.

26. The method of claim 22, further comprising:
determining IFG latent data corresponding to the set of IFG identifiers;
generating image tokens based on the IFG latent data;
generating linguistic tokens based on a query; and
using a large language model (LLM) to perform the image-based cognitive analysis based on the image tokens and the linguistic tokens to generate a response.

27. The method of claim 22, further comprising initiating transmission of the set of IFG identifiers to a device that performs the image-based cognitive analysis.

28. The method of claim 22, further comprising initiating transmission of the set of IFG identifiers to a device for the image-based cognitive analysis, wherein a multimodal transformer network is used to perform the image-based cognitive analysis based on image tokens and linguistic tokens to generate a response, and wherein the image tokens are based on the set of IFG identifiers.

29. The method of claim 22, wherein the image latent data includes a plurality of image feature embeddings corresponding to the downscaled representation of the image frame, further comprising using a codebook to determine a set of codebook indices of a plurality of codebook feature embeddings that match the plurality of image feature embeddings, and wherein the set of IFG identifiers includes the set of codebook indices.

30. A method comprising:
receiving, at a first device from a second device, a set of IFG identifiers representing an image frame;
determining, at the first device, IFG latent data corresponding to the set of IFG identifiers;
generating, at the first device, image tokens based on the IFG latent data;
generating, at the first device, linguistic tokens based on a query; and
using, at the first device, a multimodal transformer network to perform image-based cognitive analysis based on the image tokens and the linguistic tokens to generate a response.
